(19) United States
(12) Patent Application Publication
(10) Pub. No.: US 2026/0296501 A1
(43) Pub. Date: Oct. 1, 2026

(54) WORLD MODEL BASED DISTRIBUTED LEARNING FOR AI AGENTS

(71) Applicant: THE REGENTS OF THE UNIVERSITY OF CALIFORNIA, Oakland, CA (US)

(72) Inventors: Hang Wang, Davis, CA (US); Dechen Gao, Davis, CA (US); Junshan Zhang, Davis, CA (US)

(21) Appl. No.: 19/578,442

(22) Filed: Mar. 25, 2026

Related U.S. Application Data
(60) Provisional application No. 63/781,808, filed on Apr. 1, 2025.

(51) Int. Cl. B60W 60/00; B60W 50/00

(52) U.S. Cl. CPC B60W 60/0027; B60W 50/0097; B60W 2554/80; B60W 2556/10; B60W 2756/10

(57) ABSTRACT

Systems and methods for generating a trajectory prediction involving a first vehicle and a second vehicle are disclosed. The first vehicle may receive latent state and latent intention from the second vehicle, and utilize the latent state and latent intention with its own sensory data and waypoint data to generate a path prediction for the first vehicle for a plurality of future time intervals.

### CROSS-REFERENCE TO RELATED APPLICATION

This application claims priority to U.S. Provisional Application No. 63/781,808, filed Apr. 1, 2025, the disclosure of which is herein incorporated by reference in its entirety for all purposes.

### FIELD

The present disclosure generally relates to autonomous vehicles, and more specifically, systems and methods for generating a vehicle path prediction for an autonomous vehicle through lightweight information sharing between autonomous vehicles.

### BACKGROUND

Motion planning for autonomous vehicles presents a multi-agent decision making problem where each agent benefits from knowledge of the trajectory of other agents to improve their own motion planning. One approach to solving the multi-agent decision-making problem is the use of reinforcement learning (RL) where each agent performs distributed learning to make trajectory predictions. However, individual agents performing distributed RL techniques tend to suffer from insufficient information and poor prediction issues due to partial observability and non-stationarity. For example, in an autonomous vehicle environment, each vehicle may only have access to limited sensory data about its immediate surroundings, leading to incomplete knowledge of the state of the environment. As other vehicles change their driving behaviors or traffic conditions evolve, the predictions made by an agent can quickly become outdated or inaccurate, complicating decision-making processes and potentially resulting in suboptimal actions that could affect overall system performance and safety.

In order to tackle these challenges, information sharing is often employed. However, in autonomous vehicle systems, the agents (e.g., vehicles, robots, etc.) interact in a high-dimensional environment that utilizes multiple variables and states to make decisions. Such high-dimensional environment brings prohibitively large communication overhead when sharing information and generating predictions computationally intractable.

Consequently, there is a need for approaches that can effectively handle both the requirements for information sharing and the computational demands of high-dimensional environments.

### BRIEF SUMMARY

In some aspects, the techniques described herein relate to a method for generating a trajectory prediction for a vehicle, the method including: obtaining, by one or more processors, first sensory data and first waypoint data associated with a first vehicle; receiving, by the one or more processors, a latent state and a latent intention from a second vehicle, wherein the latent state represents encoded second sensory data associated with the second vehicle, wherein the latent intention represents encoded second waypoint data associated with the second vehicle; fusing, by the one or more processors, the first sensory data and the latent state into a latent fused state; applying, by the one or more processors, the latent fused state, the latent intention, and the first waypoint data into a motion planning module to generate a trajectory prediction for the first vehicle; and applying, by the one or more processors, the trajectory prediction to an autonomous control system to generate control commands for controlling the first vehicle.

In some aspects, the techniques described herein relate to a computer system for generating a trajectory prediction for a vehicle, including: one or more processors, and a tangible, non-transitory memory coupled to the one or more processors and storing executable instructions that, when executed by the one or more processors, cause the computer system to: obtain first sensory data and first waypoint data associated with a first vehicle; receive a latent state and a latent intention from a second vehicle, wherein the latent state represents encoded second sensory data associated with the second vehicle, wherein the latent intention represents encoded second waypoint data associated with the second vehicle; fuse the first sensory data and the latent state into a latent fused state; apply the latent fused state, the latent intention, and the first waypoint data into a motion planning module to generate a trajectory prediction for the first vehicle; and apply the trajectory prediction to an autonomous control system to generate control commands for controlling the first vehicle.

In some aspects, the techniques described herein relate to a non-transitory computer-readable medium storing executable instructions for generating a trajectory prediction for a vehicle that, when executed by one or more processors, causes the one or more processors to: obtain first sensory data and first waypoint data associated with a first vehicle; receive second sensory data and second waypoint data from a second vehicle; fuse the first sensory data and the second sensory data into a fused sensory data; encode the fused sensory data into a latent fused state, the first waypoint data, and the second waypoint data; apply the latent fused state, the encoded first waypoint data, and the encoded second waypoint data into a motion planning module to generate a trajectory prediction for the first vehicle; and apply the trajectory prediction to an autonomous control system to generate control commands for controlling the first vehicle.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary multi-agent autonomous vehicle communication system.

FIG. 2A illustrates a block diagram of an exemplary vehicle computing system.

FIG. 2B illustrates an example software architecture for generating a waypoint for an autonomous vehicle.

FIG. 3A illustrates a flow diagram of a multi-agent system interacting with a world model to derive generalizations.

FIG. 3B illustrates a state space model illustrating a multi-agent system interacting with a world model to derive generalizations.

FIG. 3C illustrates an algorithm that an agent in the multi-agent system uses to derive generalizations.

FIG. 4 illustrates an example bird's eye view (BEV) of an autonomous vehicle.

FIG. 5 illustrates an overall flow diagram of how an agent derives generalizations.

FIG. 6 illustrates an overall flow diagram of how an agent derives generalizations when the agent has a different encoder than other agents.

FIG. 7 illustrates a flow diagram of an exemplary computer-implemented method for generating a trajectory prediction for a vehicle.

### DETAILED DESCRIPTION

Information sharing among agents (e.g., vehicles) is one technique that may improve the performance in distributed reinforcement learning (RL). More particularly, information sharing mitigates the challenge of insufficient information available to agents for informed decision making. In the multi-agent network, each agent only has incomplete and noisy state information due to their partial observability of the driving environment. Meanwhile, from a single agent's perspective, the single agent's environment would be non-stationary as interacting agents adapt their policies. For example, when a vehicle is driving, the single agent's environment changes, making the information received by the agents to also be non-stationary.

However, conventional information sharing approaches, such as using a central server as a repository for global information or peer-to-peer communication where agents to share information to each other directly through communication channels, may be inefficient in the high-dimensional environments. For instance, the high-dimensional nature of the state (e.g., vehicle sensory data) and action spaces (e.g., waypoints) may lead to prohibitively large communication overhead. Said another way, in these conventional approaches, the data is so large that the act of transmission and reception causes the data to be outdated and/or the data involves so many dimension that traditional approaches to solving multi-agent decision-making problems (such as implement game theory-based approaches) would take too long to process.

Another major bottleneck lies in agents' constrained capability of making predictions of their intertwined environment dynamics. In particular, direct prediction (e.g., vehicle trajectory prediction) in the high-dimensional space would be computationally complex with the exponential increase of the state space dimension in multi-agent settings.

The techniques of the present disclosure relate to using a world model comprising an encoder model, a decoder model, and a prediction model (e.g., motion planning module) to derive generalizations. The generalizations can involve understanding and predicting the behavior of the environment or agents such as predicting vehicle paths, anticipating other agents' behavior, recognizing unseen obstacles, etc.

To overcome the challenge related to high dimensional data, present techniques may implement an encoder model configured to reduce high dimensional sensory data (e.g., camera data, radar data, LiDAR data, GPS data, etc.) and waypoints (e.g., points along a planned trajectory) into low dimensional latent state and latent intention. An agent may then share the low-dimensional latent state and latent intention information to other agents for use in a locally-implement RL process. As a result, by encoding the sensed data into a low-dimensional latent information, the communication overhead that exists in a conventional technique is significantly reduced, as low-dimensional representations are far more efficient to transmit. This approach allows each agent to receive essential, compressed information about other agents' states and intentions without needing to process large volumes of sensory data.

Additionally, each agent may comprise a decoder model that may decode the low-dimensional latent state and the latent intention into high-dimensional sensory data and the waypoints. In some embodiments, each agent may generate a bird's eye view (BEV) using the high-dimensional sensory data. It should be appreciated that the decoded feature space may still have lower dimensionality as compared to the raw sensor data, thereby facilitating more efficient prediction speed. Therefore, the decoded latent state of sensory data may be labeled as environment representation data. By using the encoder model and the decoder model, the present techniques improve flexibility to the multi-agent network, allowing each agent to interpret and utilize the shared latent information effectively. This approach enables agents to reconstruct detailed environmental data and planned paths from other agents without incurring the computational and communication costs associated with direct high-dimensional data sharing. Moreover, as long as the latent information is in a common format, different agents may have different decoders to decode the latent information into a preferred format for the motion planning and prediction modules implemented at that agent. Thus, the instant techniques may facilitate interoperability between agents that utilize different feature spaces for performing motion planning and prediction.

Advantageously, the encoder model and the decoder model may help reduce the communication overload that existed in conventional techniques. In conventional techniques, each additional agent contributes to a significant increase in data transmission load, leading to slower communication and potential delays. By contrast, the encoder model reduces high-dimensional sensory data and waypoints into compact, low-dimensional representations, making it far quicker and more efficient to transmit and receive data among agents. This compression significantly reduces wait times for data transmission and reception, and the reception of latent information from multiple agents contemporaneously, thereby further improving the knowledge of the local environment, enabling faster communication, and minimizing network congestion.

Moreover, the reduced data size also allows for better scalability, as additional agents can join the network without causing exponential increases in communication overhead. Additionally, the encoder and decoder architecture enhances privacy and data security by sharing only essential latent information rather than raw sensory data. Without having a proper decoder to decode the latent information (latent state and latent intention), other malicious agents may not be able to decode the latent information necessary to obtain full sensory data and waypoints.

Additionally, the techniques of the present disclosure may derive generalizations, including vehicle trajectory prediction, other vehicle states, traffic flow patterns, pedestrian behavior, and potential collision risks, by applying the prediction model using the latent information. By operating on low-dimensional latent representations rather than high-dimensional raw data, the present disclosure significantly reduces the computational complexity involved in generating these generalizations. This approach requires less processing power, making it more efficient and enabling faster prediction times. In contrast, conventional techniques relied on processing full sensory data for each generalization, leading to increased computational demands, slower predictions, and more resource-intensive operations. By focusing on latent representations, the present disclosure enables quicker, real-time derivation of essential insights, allowing agents to make informed decisions in complex environments without the delays and computational overhead of traditional methods

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care claims context, the techniques described herein may be readily applied in any suitable field for any suitable purpose.

### Exemplary Autonomous Vehicle Operation System

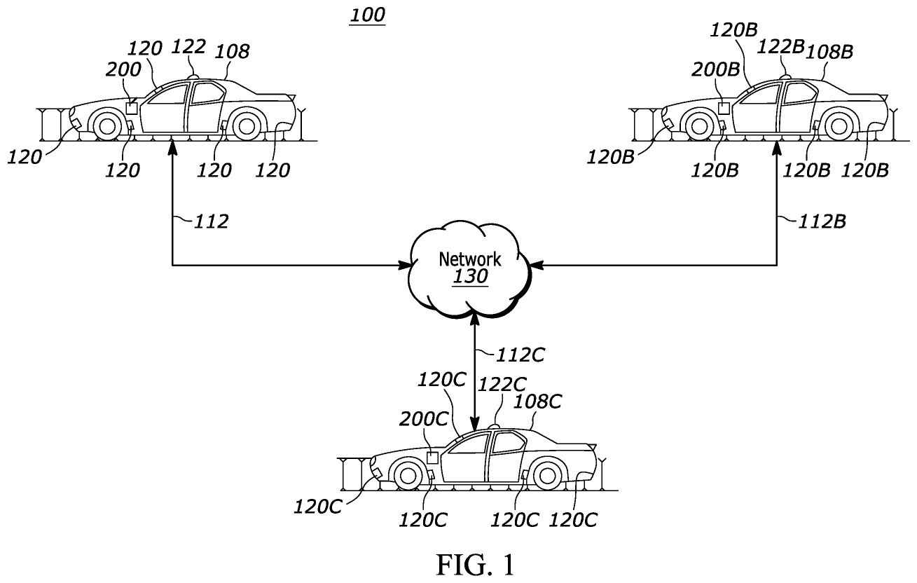

FIG. 1 illustrates a block diagram of an exemplary autonomous vehicle data system 100 on which the exemplary methods described herein may be implemented. The high-level architecture includes both hardware and software applications, as well as various data communications channels for communicating data between the various hardware and software components. A vehicle 108 may include a vehicle computing system 200, one or more sensors 120, and a communication component 122. The vehicle 108 may obtain information (e.g., sensory data) of its surroundings using the one or more sensors 120. The vehicle computing system 200 may utilize this information to operate the vehicle 108 or to assist the vehicle operator in operating the vehicle 108.

The vehicle 108 may comprise the vehicle computing system 200, which may be permanently or removably installed in the vehicle 108. The vehicle computing system 200 may interface with the one or more sensors 120 within the vehicle 108 (e.g., a digital camera, a LIDAR sensor, a RADAR sensor, an ultrasonic sensor, an infrared sensor, a millimeter wave sensor, an ignition sensor, an odometer, a system clock, a speedometer, a tachometer, an accelerometer, a gyroscope, a compass, a geolocation unit, radar unit, etc.), which sensors may also be incorporated within or connected to the vehicle computing system 200.

The vehicle 108 may further include a communication component 122 to transmit information to and receive information from external sources, including other vehicles such as vehicle 108B and vehicle 108C. The vehicle computing system 200 may communicate with the network 130 over link 112, respectively. The vehicle computing system 200 may collect, generate, process, analyze, transmit, receive, and/or act upon data associated with the vehicle 108 (e.g., sensory data, autonomous operation feature settings, or control decisions made by the autonomous operation features) or the vehicle environment (e.g., other vehicles operating near the vehicle 108).

The vehicle computing system 200 may be a general-use on-board computer capable of performing many functions relating to vehicle operation or a dedicated computer for autonomous vehicle operation. Further, the vehicle computing system 200 may be installed by the manufacturer of the vehicle 108 or as an aftermarket modification or addition to the vehicle 108.

The sensors 120 may be removably or fixedly installed within the vehicle 108 and may be disposed in various arrangements to provide information to the autonomous operation features. Among the sensors 120 may be included one or more of a GPS unit, a radar unit, a LIDAR unit, an ultrasonic sensor, an infrared sensor, an inductance sensor, a camera, an accelerometer, a tachometer, or a speedometer. Some of the sensors 120 (e.g., radar, LIDAR, or camera units) may actively or passively scan the vehicle environment for obstacles (e.g., other vehicles, buildings, pedestrians, etc.), roadways, lane markings, signs, or signals. Other sensors 120 (e.g., GPS, accelerometer, or tachometer units) may provide data for determining the location or movement of the vehicle 108. Other sensors 120 may be directed to the interior or passenger compartment of the vehicle 108, such as cameras, microphones, pressure sensors, thermometers, or similar sensors to monitor the vehicle operator and/or passengers within the vehicle 108. Information generated or received by the sensors 120 may be communicated to the vehicle computing system 200 for use in autonomous vehicle operation.

In some embodiments, the communication component 122 may receive information from external sources, such as other vehicles 108B and 108C. The communication component 122 may also send information regarding the vehicle 108 to external sources. The information may include sensory data, waypoint data, and/or hidden state data. The waypoint data may be a series of intermediate points or coordinates that represent a planned path or trajectory for an autonomous vehicle or agent to follow. The hidden state data may represent information about vehicle's past decision (e.g., speed, direction, location, etc.). In some embodiments, the sensory data, waypoint data, and/or hidden state data may be encoded (e.g., latent state and/or latent intention).

To send and receive information, the communication component 122 may include a transmitter and a receiver designed to operate according to predetermined specifications, such as the dedicated short-range communication (DSRC) channel, wireless telephony, Wi-Fi, or other existing or later-developed communications protocols. The received information may supplement the data received from the sensors 120 to implement the autonomous operation features. For example, the communication component 122 may receive information that an autonomous vehicle ahead of the vehicle 108 is reducing speed, allowing the vehicle computing system 200 to adjust in the autonomous operation of the vehicle 108.

Information sharing among vehicles, or agents, may help mitigate the challenge of insufficient information that autonomous vehicles often encounter when making informed decisions. For example, the vehicle 108B may help supplement blind side view of the vehicle 108 while driving on the roads.

In some embodiments, the vehicles 108, 108B, and 108C may share information through the network 130 by sending and receiving latent state and latent intention to reduce the large communication overhead when sending and receiving the information. The latent state may be a low-dimensional latent representation with a small memory footprint of the sensory data, and the latent intention may be low-dimensional latent representation with a small memory footprint of the waypoint data. The vehicle 108 may obtain the latent state by encoding the sensory data, and may obtain the latent intention by encoding the waypoint data. In some embodiments, the vehicle 108 may obtain the latent state by encoding both the sensory data and the hidden state data.

In addition to receiving information from the sensors 120, the vehicle computing system 200 may directly or indirectly control the operation of the vehicle 108 according to various autonomous operation features. The autonomous operation features may include software applications or modules implemented by the vehicle computing system 200 to generate and implement control commands to control the steering, braking, or throttle of the vehicle 108. To facilitate such control, the vehicle computing system 200 may be communicatively connected to control components of the vehicle 108 by various electrical or electromechanical control components (not shown). When a control command is generated by the vehicle computing system 200, the command may thus be communicated to the control components of the vehicle 108 to affect a control action. In embodiments involving fully autonomous vehicles, the vehicle 108 may be operable only through such control components (not shown). In other embodiments, the control components may be disposed within or supplement other vehicle operator control components (not shown), such as steering wheels, accelerator or brake pedals, drive mode switches, or ignition switches.

In some embodiments, the vehicle 108 may comprise an autonomous control system that generates control commands based on information (e.g., trajectory prediction) provided by the vehicle computing system 200. This autonomous control system may process the received information, generate corresponding control commands, and transmit them to the vehicle's operational subsystems (e.g., control components) to execute driving decisions. For example, the control system may regulate steering, braking, or throttle based on the predicted trajectory, ensuring precise vehicle control.

The network 130 may be a proprietary network, a secure public internet, a virtual private network or some other type of network, such as dedicated access lines, plain ordinary telephone lines, satellite links, cellular data networks, combinations of these. The network 130 may include one or more radio frequency communication links, such as wireless communication link 112 with vehicle computing system 200, respectively. Where the network 130 comprises the Internet, data communications may take place over the network 130 via an Internet communication protocol.

Other vehicles 108B and 108C may perform similarly to the vehicle 108, and may communicate with each other via links 112B and 112C through the network 130. Although the system 100 is shown to include three vehicles 108, 108B, and 108C, it should be understood that different numbers of vehicles may be utilized.

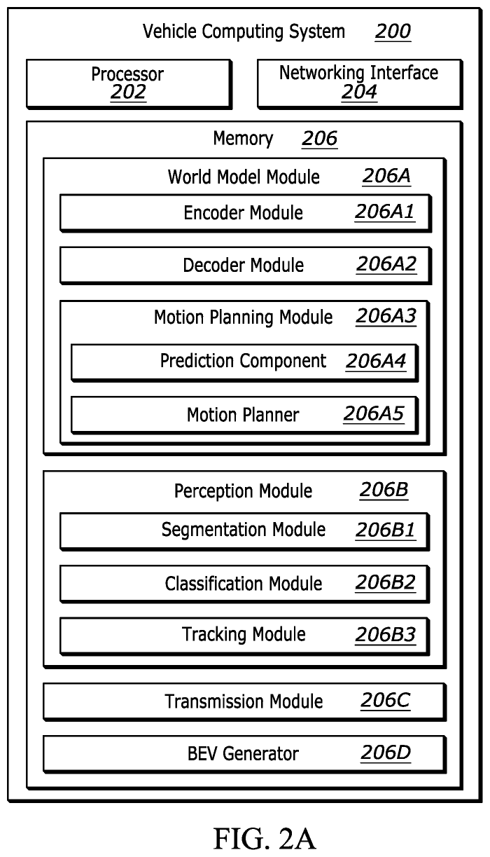

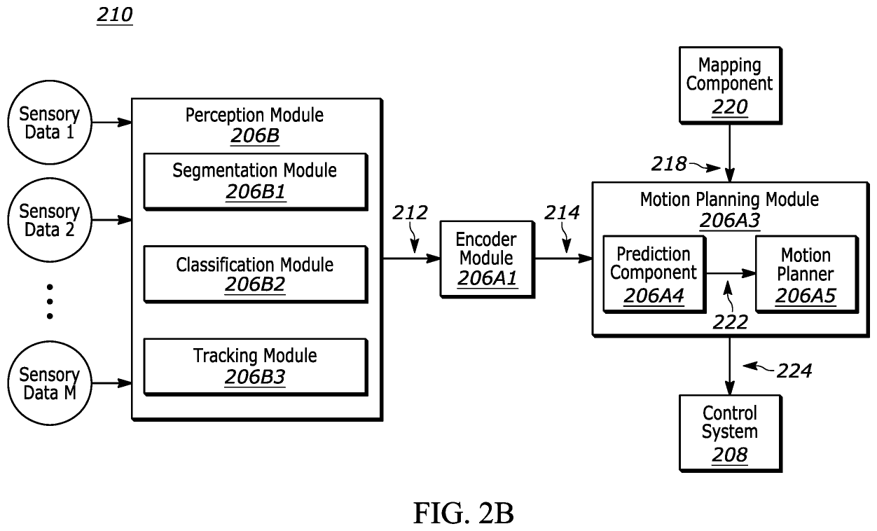

FIG. 2A is an expanded block diagram of a vehicle computing system 200, in accordance with various aspects of the present disclosure. Generally speaking, the vehicle computing system 200 obtains first sensory data and first waypoint data; receives a latent state and a latent intention from other vehicles; decode the latent state and the latent intention into a environment representation data and a second waypoint data; fuse the first sensory data and the second environment representation data into a fused sensory data; encode the fused sensory data into a latent fused state, and the first waypoint data; apply the latent fused state, the latent intention, and the encoded first waypoint data into a motion planning module to generate a trajectory prediction.

The trajectory prediction may refer to an estimated future trajectory of a vehicle and/or other moving objects within an environment. A trajectory prediction may include a set of predicted future positions and movement patterns derived from latent state data, latent intention data, sensory data, and/or shared information from other agents, as further described below. By representing an expected future state of the vehicle and its surroundings, the trajectory prediction enables proactive decision-making for navigation, collision avoidance, and cooperative maneuvers.

The trajectory prediction may also include a path prediction. The path prediction may refer to a set of predicted future positions that define a planned route for a vehicle within an environment. A path prediction may be generated based on waypoint data, sensory data, latent state data, and/or shared information from other agents to determine an intended sequence of movement. The path prediction may account for road geometry, traffic regulations, and expected maneuvers such as lane changes, turns, or stops. By providing a structured route estimation, the path prediction may enable precise motion planning and facilitate navigation in dynamic environments.

The vehicle computing system 200 includes one or more processors 202, one or more memories 206, and a networking interface 204. The memories 206 includes world model module 206A comprising an encoder module 206A1, a decoder module 206A2, and a motion planning module 206A3, a perception module 206B comprising a segmentation module 206B1, a classification module 206B2, and a tracking module 206B3, a transmission module 206C, and a bird's-eye view module 206D. In some embodiments, the vehicle computing system 200 of FIG. 2 can be the vehicle computing system 200 of FIG. 1.

The perception module 206B may generate perception signals descriptive of a current state of the autonomous vehicle's environment. It is understood that the term “current” may actually refer to a very short time prior to the generation of any given perception signals, e.g., due to the short processing delay introduced by the perception module 206B and other factors.

The segmentation module 206B1 may generally be configured to identify distinct objects within the sensory data (e.g., obtained from sensors 120B) representing the sensed environment. Depending on the embodiment and/or scenario, the segmentation task may be performed separately for each of a number of different types of sensory data, or may be performed jointly on a fusion of multiple types of sensory data. In some embodiments where lidar devices are used, the segmentation module 206B1 may analyze point cloud frames to identify subsets of points within each frame that correspond to probable physical objects in the environment. In other embodiments, the segmentation module 206B1 may jointly analyze lidar point cloud frames in conjunction with camera image frames to identify objects in the environment. Other suitable techniques, and/or data from other suitable sensor types, may also be used to identify objects. It is noted that, as used herein, references to different or distinct “objects” may encompass physical things that are entirely disconnected (e.g., with two vehicles being two different “objects”), as well as physical things that are connected or partially connected (e.g., with a vehicle being a first “object” and the vehicle's hitched trailer being a second “object”).

The segmentation module 206B1 may use predetermined rules or algorithms to identify objects. For example, the segmentation module 206B1 may identify as distinct objects, within a point cloud, any clusters of points that meet certain criteria (e.g., having no more than a certain maximum distance between all points in the cluster, etc.). Alternatively, the segmentation module 206B1 may utilize a neural network that has been trained to identify distinct objects within the environment (e.g., using supervised learning with manually generated labels for different objects within test data point clouds, etc.), or another type of machine learning based model.

For example, the segmentation module 206B1 may process the sensory data through a series of convolutional layers of the neural network. Each convolutional layer may apply filters that detect various features within the input, such as edges, textures, and object boundaries. The segmentation module may tune the filters to highlight relevant details, allowing the neural network to identify key components within the scene, such as other vehicles, lane markers, pedestrians, or obstacles. By focusing on these critical elements, the segmentation module 206B1 may begin to condense the sensory input, stripping away unnecessary background details and noise.

In another example, following the convolutional layers, the segmentation module 206B1 may pass the sensory data through pooling layers of the neural network. Pooling layers may select the most prominent feature within a region, ensuring that key signals are preserved even as the overall spatial resolution is reduced. Pooling layers may help to capture larger patterns in the environment while discarding finer details that may be less relevant for decision-making.

The classification module 206B2 may generally be configured to determine classes (labels, categories, etc.) for different objects that have been identified by the segmentation module 206B1. Like the segmentation module 206B1, the classification module 206B2 may perform classification separately for different sets of the sensory data, or may classify objects based on data from multiple sensors, etc. Moreover, and also similar to the segmentation module 206B2, the classification module 206B2 may execute predetermined rules or algorithms to classify objects, or may utilize a neural network or other machine learning based model to classify objects.

In some implementations, the classification module 206B2 may communicate with an object database (not depicted) that stores information associated with object types. For example, the object database may include information that indicates how an object of the corresponding object type should appear in a point cloud. In some implementations, this indication may be a generic model for an object of the particular type. As one example, an object database record for a particular model of car may include a three-dimensional model of the car, to which objects identified by the segmentation module 206B1 are compared during the classification process. In some additional implementations, the model includes indications of particular features of the object that have known shapes (e.g., a license plate, a tire, manufacturer emblem, etc.). As will be described below, this model of the object, including the particular features thereof, may be used to detect whether objects identified by the segmentation module 206B2 actually have a skewed shape, or instead have a distorted appearance in the point cloud frame due to rolling shutter distortion.

The tracking module 206B3 may generally be configured to track distinct objects over time (e.g., across multiple lidar point cloud or camera image frames). The tracked objects are generally objects that have been identified by the segmentation module 206B1, but may or may not be objects that were classified by the classification module 206B2, depending on the embodiment and/or scenario. The segmentation module 206B1 may assign identifiers to identified objects, and the tracking module 206B3 may associate existing identifiers with specific objects where appropriate (e.g., for lidar data, by associating the same identifier with different clusters of points, at different locations, in successive point cloud frames). Like the segmentation module 206B1 and the classification module 206B2, the tracking module 206B3 may perform separate object tracking based on different sets of the sensory data, or may track objects based on data from multiple sensors. Moreover, and also similar to the segmentation module 206B1 and the classification module 206B2, the tracking module 206B3 may execute predetermined rules or algorithms to track objects, or may utilize a neural network or other machine learning model to track objects.

The encoder module 206A1 may encode high dimensional data (e.g., bigger feature space) into low dimensional data (e.g., smaller feature space). For example, the encoder module 206A1 may encode high dimensional sensory input (e.g., images from cameras) into a low-dimension latent state. In another example, the encoder module 206A1 may encode high dimensional perception signals from the perception module 206B into low dimensional latent state. The encoder module 206A1 may pass the sensory input through several layers of a neural network (e.g., recurrent neural network (RNN)). The neural network may then condense the relevant features into a compact, low-dimensional representation or latent state, which captures essential information while discarding irrelevant details. The vehicle computing system 200 may use the latent state for decision-making or share with other agents (e.g., vehicles). By encoding sensory input into latent states, the vehicle computing system 200 may minimize memory and computational requirements, enabling efficient communication and improving prediction capabilities across the agent network. Latent representations may have a much smaller memory footprint compared to the high-dimension sensory inputs, making lightweight information sharing much more feasible in practice.

The encoding module 206A1 may apply the high-dimensional sensory data into a set of fully connected (dense) layers of the neural network. These layers may take the two-dimensional feature maps (e.g., sensory data such as images) and transform them into a compact, fixed-size vector known as the latent state. The fully connected layers may ‘flatten’ the features, combining the features into a concise representation that encapsulates the core information about the environment. This transformation may serve as a bottleneck, forcing the encoder module 206A1 to retain only the most critical aspects of the input, ensuring that the resulting latent state is both compact and highly informative.

In some embodiments, the encoder module 206A1 may processes the high-dimensional sensory data and the high-dimensional hidden state data through a series of recurrent layers of the neural network. These recurrent layers, such as Long Short-Term Memory (LSTM) units or Gated Recurrent Units (GRUs), are designed to capture temporal dependencies and relationships across sequential inputs. By iteratively updating the hidden state, the recurrent layers encode both the current sensory data and the historical context contained in the hidden state, allowing the encoder module 206A1 to generate a compact, low-dimensional latent state representation. This representation combines the most relevant information from past and present inputs, enabling downstream processes to make informed predictions or decisions based on the condensed and temporally aware encoding of the environment.

The encoder module 206A1 may apply the same neural network to the waypoint data of the vehicle 108 to determine a latent intention. The waypoint data may be a sequence of target coordinates or positions that outline the vehicle's planned trajectory over a given time horizon. By encoding the waypoint data into the latent intention, the encoder provides a compact representation of the vehicle's intended path, which can be shared with other agents.

The latent data including the latent state data and the latent intentions may be deemed as “locally sufficient information” for the vehicle computing system 200 to make decisions and improve predictions using the motion planning module 206A3.

The decoder module 206A2 may decode the latent data encoded by the encoder module 206A1. The latent data may comprise latent state (e.g., encoded sensory data) and/or latent intention (e.g., encoded waypoint data). The decoder module 206A2 may decode the lower-dimensional latent data to a higher-dimension sensory data and/or the waypoint data. The vehicle computing system 200, upon receiving the latent data, may use the decoder module 206A2 to decode one or more latent state and the latent intention, and obtain one or more sensory data and waypoint data from other vehicles.

The decoder module 206A2 may decode the latent data by passing the latent data through several layers of a neural network (e.g., Recurrent Neural Network). These layers may transform the compact, low-dimensional latent representation back into a higher-dimensional form that resembles the original sensory data or waypoint data. For example, the decoder module 206a2 may use deconvolutional layers to up-sample the latent data, gradually reconstructing details that were previously condensed by the encoder module 206A1. Through this process, the decoder may recover key spatial and temporal details necessary for accurate perception and navigation.

The decoder module 206A2 may train the neural network layers within the decoder to reconstruct high-fidelity representations of sensory inputs, such as images, enabling the vehicle computing system 200 to interpret detailed information about nearby agents' positions, velocities, and intentions. For example, the decoder module 206A2 may regenerate an approximate image or positional data that provides insights into the environment surrounding other vehicles. This capability allows the vehicle computing system 200 to assess the relative positions of objects, obstacles, and road features, even when the original high-dimensional data was not directly shared.

Additionally, the decoder module 206A2 may apply recurrent layers to the latent intention data, which may capture the sequential nature of waypoint paths and predicted trajectories. These recurrent layers enable the decoder module 206A2 to reconstruct temporal sequences, such as the planned trajectory and expected maneuvers of other vehicles. By decoding latent intentions in this way, the vehicle computing system 200 may gain foresight into other vehicles' future actions, allowing for more informed planning and coordination in multi-agent environments.

After decoding, the vehicle computing system 200 may utilize the reconstructed sensory and waypoint data to enhance its situational awareness and decision-making processes. By integrating this data with its own sensory inputs, the decoder module 206A2 may achieve a more comprehensive view of the environment.

The prediction component 206A4 may process the latent state to generate prediction signals descriptive of one or more predicted future states of the autonomous vehicle's environment. For a given object, for example, the prediction component 206A4 may analyze the type/class of the object (as determined by the classification module 206B2) along with the recent tracked movement of the object (as determined by the tracking module 206B3) to predict one or more future positions of the object. As a relatively simple example, the prediction component 206A4 may assume that any moving objects will continue to travel in their current direction and with their current speed, possibly taking into account first- or higher order derivatives to better track objects that have continuously changing directions, objects that are accelerating, and so on. In some embodiments, the prediction component 206A4 may also predict movement of objects based on more complex behaviors. For example, the prediction component 206A4 may assume that an object that has been classified as another vehicle will follow rules of the road (e.g., stop when approaching a red light), and will react in a certain way to other dynamic objects (e.g., attempt to maintain some safe distance from other vehicles). The prediction component 206A4 may inherently account for such behaviors by utilizing a neural network or other machine learning model, for example. It should be appreciated that if an object corresponds to an agent from which the vehicle computing system 200 received encoded latent information, the latent information (either encoded or decoded) may be analyzed by the prediction component 206A4 to predict futures states of the agent.

The motion planner 206A5 may process the latent state and/or the prediction signals to generate waypoint data, or a series of intermediate points or coordinates that represent a planned path or trajectory. The vehicle computing system 200 may utilize its own latent state and prediction signals (vehicle 180), such as tracked objects and environmental cues, to create waypoints for navigating the vehicle.

The routing planning module 206A3 may also utilize latent state and latent intention (e.g., encoded waypoint data) from other vehicles to derive generalizations (e.g., predicted future states of the environment, trajectory predictions, etc.) along with its own latent state and latent intention. For example, the routing planning module 206A3 may use the prediction component 206A4 to predict future states of the environment, and use the motion planner 206A5 to generate a trajectory prediction. By leveraging the shared latent states and latent intentions from nearby agents, the motion planner 206A5 can derive generalizations about the collective environment. For example, it may anticipate lane changes, braking behaviors, or traffic flow patterns based on other vehicles' intentions and trajectories. Combining its own latent intention, latent state, sensory data, and shared information enables the routing planning module 206A3 may determine well-informed trajectory predictions and plan cooperative maneuvers. The motion planning module 206A3 may control the vehicle based on the predicted path and planned cooperative maneuvers, such as yielding, merging, or adjusting speeds in response to anticipated behaviors of nearby agents.

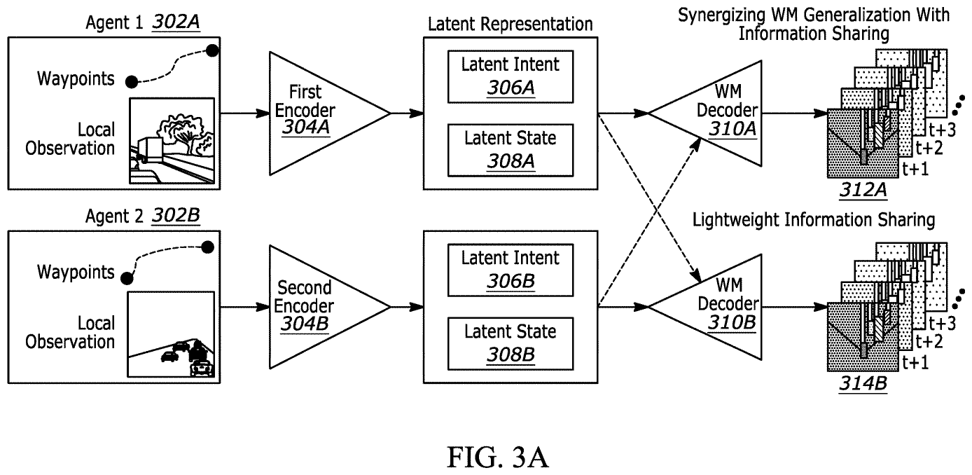

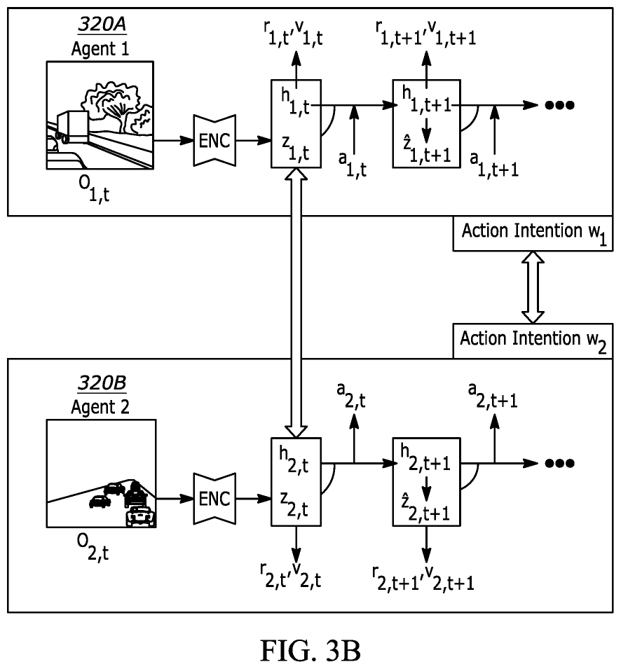

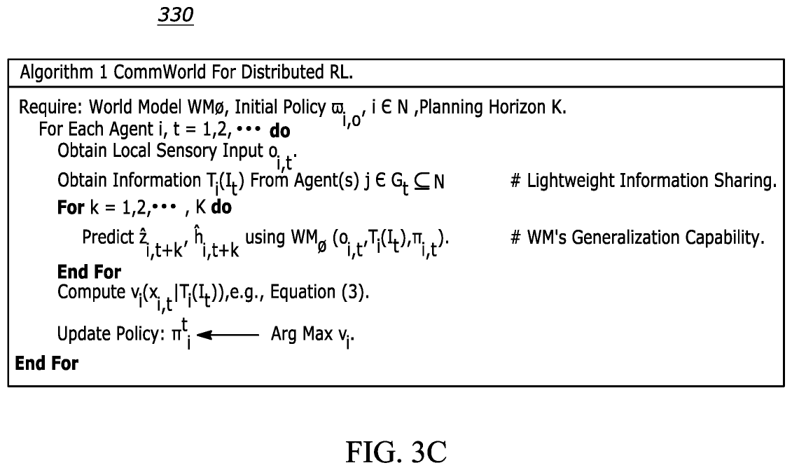

The motion planning module 206A3 may also utilize a memory-augmented neural network (e.g., a recurrent neural network) to process the latent data (e.g., latent state and latent intention) and derive generalizations. These generalizations enable the vehicle computing system 200 to predict future states (e.g., future latent state \hat{z}ₜ₊ₖ) and plan its actions (e.g., action aₜ₊ₖ) accordingly. Specifically, the motion planning module 206A3 may determine insights such as vehicle trajectory predictions, anticipated behaviors of nearby agents, traffic flow patterns, potential collision risks, and optimal navigational strategies. By leveraging these capabilities, the motion planning module 206A3 enables the vehicle to plan and control safe and efficient maneuvers based on the trajectory prediction, such as adjusting speed, changing lanes, or preparing to yield, thereby improving its adaptability and responsiveness to dynamic, real-world driving environments. Details of deriving generalizations can be found in FIG. 3B.

The transmission module 206C may choose to send and/or receive information from vehicles that are within a predefined distance threshold. For example, the vehicle may choose to send and receive the latent state and/or latent intention among vehicles within 5-mile radius. The predefined distance threshold may be based on a broadcasting signal range of the first vehicle, or may be based on a global positioning system (GPS) distance. In some embodiments, the transmission module 206C may prioritize certain vehicles in sending the latent state data and/or latent intention data. For example, the vehicle computing system 200 may prioritize sending the latent state and/or intention data to vehicles in close proximity or those likely to be affected by the planned maneuvers of the vehicle 108, such as those in adjacent lanes or directly behind when preparing to change lanes. Additionally, if the vehicle computing system 200 detects that certain vehicles are approaching quickly or are in potential collision paths, the vehicle computing system 200 may transmit updated latent information more frequently to enable better situational awareness for those vehicles. Conversely, for vehicles farther away or not directly relevant to the vehicle 108's immediate path, the vehicle computing system 200 may limit or omit latent information transmission to conserve bandwidth and processing resources.”

In some embodiments, the transmission module 206C may choose which latent information (or subset of the sensory data) to send out to other vehicles. When the vehicle computing system 200 chooses to send out latent state and/or the latent intention (or sensory data and/or waypoint data) to other vehicles, the transmission module 206C may determine which vehicles may need what information. For example, in a lane-changing task, it may suffice for the vehicle 108 to send only its lateral movement intentions and speed data to vehicles (e.g., vehicle 108B and vehicle 108C) in adjacent lanes, as these vehicles would be most impacted by an upcoming lane shift. Specifically, the vehicle computing system 200 may transmit the vehicle 108's intended trajectory within the lane, projected speed changes, and any planned accelerations or decelerations, which could help nearby vehicles anticipate and react appropriately to the lane change.

The transmission module 206C may additionally choose which latent information (or subset of the sensory data) to send out to other vehicles based on an absolute position of the vehicle 108 to another vehicle (e.g., vehicle 108B). For example, the vehicle 108 may transmit more comprehensive sensory data, such as its immediate surrounding view (e.g., obstacles, lane markings, and nearby vehicles), precise projected acceleration and deceleration, and detailed trajectory predictions, to vehicles within a close range, as these vehicles are more likely to be impacted by the vehicle 108's maneuvers. In contrast, the vehicle 108 may transmit less comprehensive sensory data, such as basic information about its current speed, heading, and general movement intentions, to vehicles that are farther away.

The transmission module 206C may determine which information to send and/or receive using a context-aware filtering mechanism. The context-aware filtering mechanism may analyze the vehicle's current task (e.g., lane-changing, merging, or maintaining speed) and prioritize data that is most relevant to that task. For instance, when performing a merging maneuver, the transmission module 206C may prioritize data on the lateral and longitudinal positions, speeds, and intentions of vehicles in adjacent lanes or those directly ahead and behind in the merging lane. It may deprioritize or ignore data from vehicles several lanes away or those whose movements are unlikely to impact the merging process.

In some embodiments, the transmission module 206C may determine which information to send and/or receive using a prediction-accuracy-driven information sharing mechanism. This mechanism may evaluate prediction errors by comparing previous trajectory predictions including previously predicted latent states and intentions against actual observations over recent time steps. When the prediction error exceeds a predefined threshold, the transmission module 206C may adapt its communication range and exchange further relevant latent information. For instance, when performing a merging maneuver and the prediction error is high, the transmission module 206C may increase the communication range (e.g., by increasing the range of its transceivers) to obtain additional information about vehicles in adjacent lanes or those directly ahead and behind in the merging lane. This adaptive approach ensures only lightweight and targeted information sharing takes place, reducing unnecessary communication overhead while maintaining prediction accuracy.

This context-aware filtering mechanism could be implemented using different approaches. A rule-based system with predefined rules may prioritize or ignore data based on specific tasks and conditions, such as only receiving data from nearby vehicles during merging, which is simple, low-cost, and predictable but less flexible in complex scenarios. Alternatively, a machine learning model could dynamically filter data by recognizing patterns relevant to various situations, such as using reinforcement learning to optimize safe and efficient driving across traffic scenarios, though this requires more computational resources and training data. A hybrid approach may combine rule-based logic for straightforward cases with a machine learning model for complex situations, such as dense traffic merging, balancing simplicity and flexibility for efficient adaptation to varied driving conditions.

In some embodiments, the transmission module 206C may use real-time situational analysis, considering environmental factors such as the vehicle's speed, proximity to other vehicles, and the density of traffic, to further refine which information is necessary. Similar to the context-aware filtering mechanism, the situational analysis may involve machine learning algorithms or rule-based systems to assist in making these decisions, allowing the vehicle to dynamically adjust its data-sharing preferences based on changes in traffic or road conditions.

The transmission module 206C, by focusing on sending and receiving only the most relevant information for the current task (e.g., context aware filtering) and/or the current environment (e.g., real-time situational analysis), may conserve bandwidth, optimize processing resources, and ensure that the vehicle computing system 200 remains focused on critical data needed for safe and efficient navigation.

The BEV generator module 206D may generate a bird's eye view (BEV) of the vehicle 180's environment using the sensory data and waypoint data. The BEV generator module 206D may transform raw sensory inputs, such as camera images, LiDAR point clouds, radar data, and GPS coordinates, into a top-down representation of the surroundings. The sensory data may provide real-time information about the vehicle's environment, including the location of other vehicles, lane markings, obstacles, and road features. The waypoint data, which represents the planned trajectory of the vehicle, is overlaid onto the BEV to provide a visual representation of the intended path. By integrating these inputs, the BEV generator module creates a comprehensive and intuitive map that highlights both the current state of the environment and the vehicle's planned movement. In some embodiments, the BEV generator module 206D may combine different BEVs of different vehicles to its own BEV. For example, the BEV generator module 206D may determine a fused BEV based on the fused sensory data and the fused waypoint data. In some embodiments, where the decoded feature space represents a BEV of the environment proximate to the vehicle computing system 200, the decoder module 260A2 may invoke the BEV generator 206D when decoding received encoded latent information.

FIG. 2B illustrates an example software architecture of a vehicle computing system 200 generating waypoints for a vehicle (e.g., vehicle 180) using sensory data 210. The software architecture may receive as input M sets of sensory data 210 generated by M different sensors, with M being any suitable integer equal to or greater than one. The sensor data 210 may be data generated by the sensors 120 of FIG. 1. For example, the sensors 120 may include one or more of a GPS unit, a radar unit, a LIDAR unit, an ultrasonic sensor, an infrared sensor, an inductance sensor, a camera, an accelerometer, a tachometer, or a speedometer.

The perception module 206B may comprise the segmentation module 206B1, the classification module 206B2, and the tracking module 206B3. The perception module 206B may process the sensory data 210 into perception signals 212 describing a current state of the autonomous vehicle's environment. The segmentation module 206B1 may identify distinct objects within the sensory data 210 using predetermined rules or algorithms (as specified in segmentation module 206B1 of FIG. 2A). The classification module 206B2 may classify (labels, categories, etc.) for different objects that have been identified by the segmentation module 206B1 (as specified in classification module 206B2 of FIG. 2A). The tracking module 206B3 may track distinct objects identified in the segmentation module 206B1, and may assign identifiers to the identified objects (as specified in tracking module 206B4 of FIG. 2A).

The encoder module 206A1 may then encode the perception signals 212 and other sensory data that were not processed into perception signals 212 (e.g., GPS data) into a latent state. In some embodiments, the software architecture may use hidden state (e.g., historical waypoint data and historical sensory data) of the vehicle in addition to the sensory data, and encode the hidden state along with the perception signals 212 and the sensory data to determine the latent state. The prediction component 206A4 may process the latent state to generate prediction signals 222 descriptive of one or more predicted future states of the autonomous vehicle's environment (as specified in prediction component 206A4 of FIG. 2B).

A mapping component 220 obtains map data (e.g., a digital map including the area currently being traversed by the autonomous vehicle) and/or navigation data (e.g., data indicating a trajectory for the autonomous vehicle to reach the destination, such as turn-by-turn instructions), and outputs the data (possibly in a converted format) as mapping and navigation signals 218. In some embodiments, the mapping and navigation signals 218 may include other map- or location related information, such as speed limits, traffic indicators, and so on. The signals 218 may be obtained from a remote server (e.g., via a cellular or other communication network of the autonomous vehicle, or of a smartphone coupled to the autonomous vehicle, etc.), and/or may be locally stored in a persistent memory of the autonomous vehicle.

The motion planner 206A5 may then process the latent state 214, the prediction signals 222, and the navigation signals 218 to generate the waypoint 224 and/or a trajectory prediction. The vehicle computing system 200 may utilize the software architecture of FIG. 2B and its own sensory data 210 to create waypoints and/or the trajectory prediction for navigating the vehicle (e.g., vehicle 180). The motion planner 206A5 may then transmit the trajectory prediction to a control system 208 to generate control commands for controlling the vehicle.

The control system 208 may process the trajectory prediction and generate control commands for the vehicle's operational subsystems (e.g., control components), enabling the vehicle to autonomously execute driving decisions. For example, the control system 208 may generate and implement commands to regulate the vehicle's steering, braking, or throttle based on the predicted trajectory. In some embodiments, the control system 208 may function independently from the vehicle computing system 200, autonomously generating and executing control signals based on the trajectory prediction to operate the vehicle.

### Exemplary Process Flows

FIG. 3A illustrates a flow diagram of a multi-agent system deriving generalizations (e.g., trajectory predictions). The multi-agent system may comprise a first agent 302A (e.g., first vehicle) and a second agent (e.g., second vehicle) 302B. The first agent 302A may collect a first sensory data (e.g., local observations) from one or more sensors (e.g., one or more sensors 120) and first waypoint data (e.g., from software architecture of FIG. 2B). The second agent 302B may collect a second sensory data (e.g. local observations) from one or more sensors (e.g., one or more sensors 120B) and second waypoint data. The waypoint data may be a sequence of intermediate target points or coordinates guiding the vehicle's path.

The first agent 302A may use a first encoder 304A (e.g., encoder module 206A1) to encode the first sensory data into a first latent state 308A, and encode the first waypoint data into a first latent intention 306A. In some embodiments, the first agent 302A may define a subset of the first sensory data based on an absolute position of the first agent 302A to the second agent 302B, and encode the subset of the first sensory data as the first latent state 308A. The first agent 302A may then transmit the first latent data comprising the first latent intention 306A and the first latent state 308A to the second agent 302B.

The second agent 302B may use a second encoder 304B to encode the second sensory data into a second latent state 308B, and encode the second waypoint data into a second latent intention 306B. In some embodiments, the second agent 302B may define a subset of the second sensory data based on an absolute position of the second agent 302B to the first agent 302A, and encode the subset of the second sensory data as the second latent state 308B. The second agent 302B may then transmit the second latent data comprising the second latent intention 306B and the second latent state 308B to the first agent 302A. In some embodiments, the second agent 302B may select which latent data to send to the second agent 302B.

The first agent 302A, upon receiving the second latent state 308B and the second latent intention 306B, may decode the second latent state 308B and the second latent intention 306B using the decoder 310A (e.g., decoder module 206A2) to determine the second environment representation data and the second waypoint data. The first agent 302A may then combine the first sensory data and the second environment representation data to generate fused sensory data. The fused sensory data, the first waypoint data, and the second waypoint data may provide the first agent 302A with an enhanced understanding of its surrounding environment by integrating information from both its own observations and those received from the second agent 302B. By combining sensory data, the first agent 302A can build a more complete and accurate representation of nearby vehicles, obstacles, and road conditions, which can improve its situational knowledge when performing trajectory predictions. Similarly, additional waypoint data offers insights into the planned paths of both agents, enabling the first agent 302A to anticipate potential interactions or conflicts along its trajectory.

The second agent 302B, upon receiving the first latent state 308A and the first latent intention 306A, may decode the first latent state 308A and the first latent intention 306A using the decoder 310B to determine the first environment representation data and the first waypoint data. The second agent 302B may then combine the first environment representation data and the second sensory data to determine the fused sensory data to determine the fused sensory data.

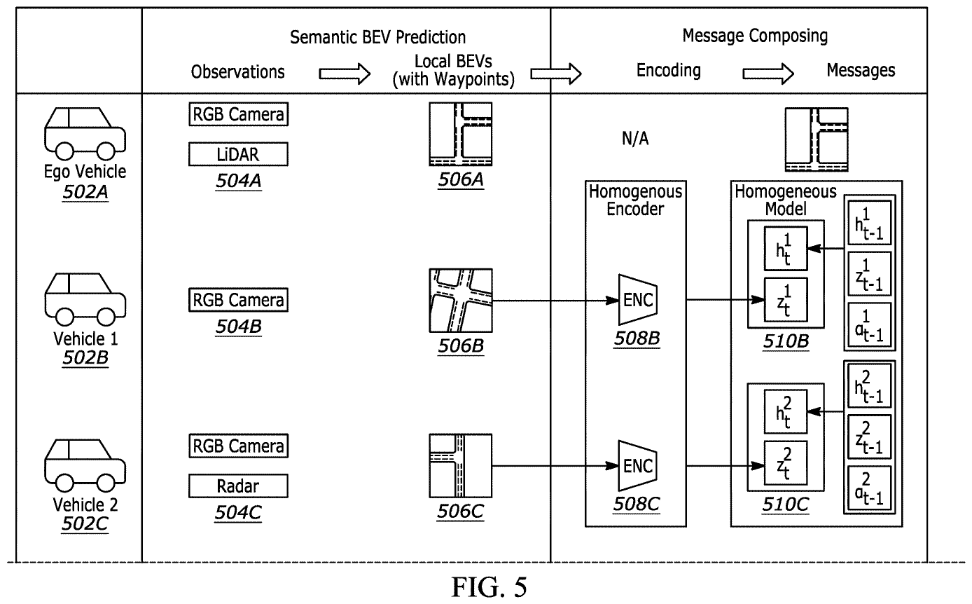

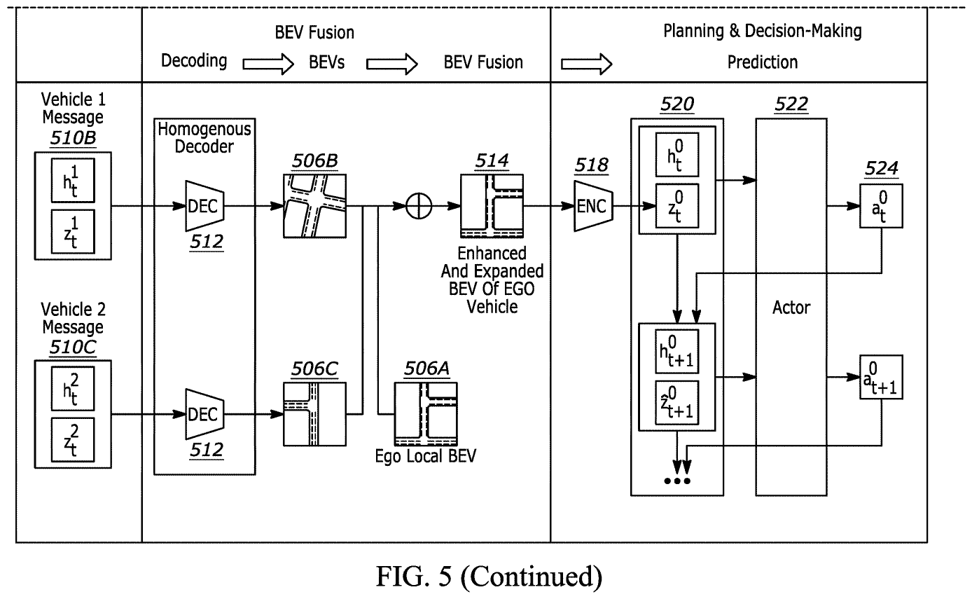

The first agent 302A may then encode the fused sensory data into a latent fused state, the first waypoint data into the first latent intention 306A, and the second waypoint data into the second latent intention 306B. The first agent 302A may then use the latent fused state, the first latent intention 306A, and the second latent intention 306B to derive a first set of generalizations 312A for a plurality of future time intervals. These generalizations may include predictions about the positions, speeds, and trajectories of other agents, as well as anticipated changes in the environment, such as obstacles or road conditions. By simulating potential scenarios over a range of future time steps, the first agent 302A can assess the likely outcomes of various decisions, enabling it to choose actions that optimize its safety and efficiency. Similarly, the second agent 302B may then use the fused sensory data and the fused waypoint data to determine the latent fused state, the first latent intention 306A, and the second latent intention 306B, and derive a second set of generalizations 314B for a plurality of future time intervals. Details of forming the generalizations can be found in FIG. 3B and FIG. 5.

In some embodiments, the first agent 302A, upon receiving the second latent state 308B, may combine the first sensory data and the second latent state 308B to determine a latent fused state directly. The first encoder 304A and the first decoder 310A, being the same encoder/decoder type as the second encoder 304B and the second decoder 310B, allow the first agent 302A to process and integrate the received latent state without requiring explicit decoding. Because both agents utilize the same encoding architecture, the latent state 308B may already exist in a structured, compressed form that retains meaningful features relevant to decision-making. Similarly, the second agent 302A, may combine the second sensory data and the first latent state 308A to determine the latent fused state.

### Decision Making Model

The multi-agent system using a world model (e.g., world model module 206A) to derive generalizations may be represented in a mathematical framework, with variables indicating different states, spaces, actions, and observations within the environment. This framework may enable each agent (e.g., vehicle) to encode, process, and predict relevant information about its surroundings and the behavior of other agents. Mathematical constructs, such as state transition functions and reward functions, allow agents to evaluate the impact of their actions and learn policies that maximize expected rewards over time. This structured mathematical framework may provide a foundation for encoding complex multi-agent interactions and enables the system to predict future states, determine optimal actions, and generalize across various scenarios.

The distributed decision making problem in the multi-agent system may cast as a (partial-observable) stochastic game (S, {Aᵢ}_{i∈N}, P, {rᵢ}_{i∈N}, {Ωᵢ}_{i∈N}, γ), where N is the set of N agents in the system, S⊆R^{ds} is the state space of the environment, and Ωᵢ and Aᵢ are the observation space and action space for agent i∈N, respectively. The stochastic game may be a mathematical framework where multiple agents make decisions in an environment (e.g., driving) that change probabilistically. Each agent has a partial observation space Ωᵢ, as they can only observe part of the environment, leading to a partially observable setting. Each agent i has its own set of possible actions, represented by Aᵢ. S may represent all possible states of the environment. P may represent a state transition function going from one state s^{t} at time t to another state s^{t+1} at time t+1. Meanwhile, the multi-agent system may assume the state space to be compact, implying that the environment's possible states are limited to a finite region, and assume the action space to be finite, meaning each agent has a limited, countable set of actions. γ∈[0, 1) may represent a discounting factor. The discount factor γ∈[0,1) may determine how much future rewards are valued compared to immediate rewards, where a value closer to 1 places more importance on long-term rewards. In a single agent's perspective, each agent's decision-making problem may be viewed as a Partial-Observable Markov Decision Process (POMDP), as each agent has only partial observations.

At each time step t, each agent i may choose an action a_{i,t} by following policy πᵢ: S→A, and denote the joint action by aₜ=[a_{1,t} . . . , a_{N,t}]∈A, where the joint action aₜ includes the actions of all agents [a_{1,t} . . . a_{N,t}], and represented by A:=ΠᵢAᵢ, which may represent the product of all agents' action spaces. The action a_{i,t} may also be labeled as a waypoint data of agent i at time t. Then the environment may evolve from sₜ to sₜ₊₁ following the state transition function P(sₜ₊₁|sₜ, aₜ) in the domain of S×A×S→[0, 1]. Each agent i may have a partial observation, e.g., sensory inputs of an autonomous vehicle, o_{i,t}∈Ωᵢ and receive the reward r_{i,t}:=rᵢ(sₜ, aₜ).

Each agent in the multi-agent system may aim to train a world model WM to represent the latent dynamics of the environment and predict the reward r and future latent state z. Each component of the world model may be implemented as a neural network and φ may be the combined parameter vector. The world model WM may comprise following models:

$$\text{Sequence Model:} {h}_{t} = {f}_{ϕ} ( {h}_{t - 1} , {z}_{t - 1} , {a}_{t - 1} , {T}_{t} ) \\ \text{Encoder:} {z}_{t} ∼ {q}_{ϕ} ( {z}_{t} \vert {h}_{t} , {o}_{t} , {T}_{t} ) \\ \text{Dynamics Predictor:} \hat{{z}_{t}} ∼ {p}_{ϕ} ( \hat{{z}_{t}} \vert {h}_{t} ) \\ \text{Reward Predictor:} \hat{{r}_{t}} ∼ {p}_{ϕ} ( \hat{{r}_{t}} \vert {h}_{t} , {z}_{t} ) \\ \text{Contuinue Predictor:} \hat{{c}_{t}} ∼ {p}_{ϕ} ( \hat{{c}_{t}} \vert {h}_{t} , {z}_{t} ) \\ \text{Decoder:} \hat{{x}_{t}} ∼ {p}_{ϕ} ( \hat{{x}_{t}} \vert {h}_{t} , {z}_{t} )$$

An augmented model p_{φ} and the sequence model f_{φ} may be part of the memory augmented neural network of the motion planning module 206A3. Tₜ may represent the shared information from other agents at time t. This information may be shared based on a prediction-accuracy-driven approach, where prediction errors are continuously monitored to determine when information sharing is necessary. The prediction error at step k may be characterized by the difference between the predicted state and the true state, which can be improved through effective information sharing as described in the theoretical analysis. In some embodiments, the dynamics predictor may be labeled as state representation predictor.

The world model WM may first learn a latent state z_{i,t}∈Z⊆R^{d} based on the agent's partial observation from sensory inputs o_{i,t} through encoding. Moreover, the world model WM may use a recurrent state-space (e.g., RSS) model as an encoder q_{φ} to capture the context information of the current observation in the latent space by incorporating the hidden state h that provides context and past history data about the vehicle, i.e.,

$$\text{Encoder:} {Z}_{i , t} ∼ {q}_{ϕ} ( {z}_{i , t} \vert {h}_{i , t} , {o}_{i , t} ) .$$

The encoder processes two key inputs: the hidden state h_{i,t}, which encapsulates historical context about past states and actions, and the observation o_{i,t}, which consists of real-time sensory data (e.g., camera images, LiDAR scans). By combining these inputs, the encoder captures the temporal dependencies and spatial features of the environment, producing a latent state z_{i,t} that represents a concise yet informative summary of the agent's state. In some embodiments, the concatenation of h_{i,t} and z_{i,t} as the model may be represented as x_{i,t}:=[h_{i,t}, z_{i,t}]∈X.

Then a sequence model f_{φ}, e.g., RNN, may predict the next hidden state h_{i,t+1} given joint action at, i.e.,

$$\text{Sequence Model:} {h}_{i , t + 1} ∼ {f}_{ϕ} ( {x}_{i , t} , {a}_{i , t} )$$

the sequence model predicts the next hidden state h_{i,t+1} based on the current state x_{i,t} and the current action a_{i,t}. f_{φ} may be a parameterized function, often implemented as a recurrent neural network (RNN) or similar architecture, designed to capture temporal dependencies and dynamics within sequential data. The next hidden state h_{i,t+1} acts as a compact representation of the agent's historical context, integrating past observations, actions, and transitions to inform future decisions. This enables the sequence model to handle complex, dynamic environments by retaining relevant temporal information and allowing the vehicle computing system to adapt its predictions and actions as the environment evolves.

Based on the determined next hidden state h_{i,t+1}, the agent may predict next latent state ż_{i,t+1} using an augmented model p_{φ} (e.g., memory augmented neural network), i.e.,

$$\text{Dynamics Predictor:} {\hat{z}}_{i , t + 1} ∼ {p}_{ϕ} ( {\hat{z}}_{i , t + 1} \vert {h}_{i , t + 1} ) .$$

The dynamics predictor is a component designed to predict future latent states based on the current hidden state. The dynamics predictor models how the environment is expected to evolve over time. Using the next hidden state h_{i,t+1}, which encapsulates historical context and temporal dependencies, the dynamics predictor estimates the next latent state ż_{i,t+1}. This future latent state provides a compact and abstract representation of the anticipated environment, enabling the system to predict key aspects such as the movement of nearby vehicles, changes in traffic patterns, or evolving road conditions.

Based on the next model state, WM also predicts the reward using the augmented model p_{φ}, i.e.,

$$\text{Reward Predictor:} {\hat{r}}_{i , t + 1} ∼ {p}_{ϕ} ( {\hat{r}}_{i , t + 1} \vert {x}_{i , t + 1} ) .$$

The reward predictor estimates the reward at the next time step t+1 based on the predicted state x_{i,t+1}=[h_{i,t+1}, \hat{z}_{i,t+1}]. This reward prediction enables the system to evaluate the potential benefits or consequences of actions taken. Determining a reward r_{i,t} may use the same augmented model using the hidden state and the latent state z_{i,t}.

In some embodiments, the reward may be weight sum of five different attributes including safety, comfort, driving time, velocity, and distance to the waypoint. For example, the reward may be represented as Rₜ=w₁R_{safe}+w₂R_{comfort}+w₃Rₜᵢₘₑ+w₄R_{velocity}+w₅Rₒᵣᵢ+w₆R_{target}

Based on the model state, WM also predicts the continuation using the augmented model p_{φ} i.e.,

$$\text{Continue Predictor:} {\hat{c}}_{i , t + 1} ∼ {p}_{ϕ} ( {\hat{c}}_{i , t + 1} \vert {x}_{i , t + 1} ) .$$

The continue predictor predicts whether the episode or task should continue based on the predicted state x_{i,t+1}. This flag provides a binary or probabilistic indication of whether the current trajectory or strategy remains viable. Determining a continuation c_{i,t} may use the same augmented model using the hidden state and the latent state z_{i,t}.

In multi-agent system, each agent i may learn a policy πᵢ, i∈N, in a distributed manner, aided by lightweight information sharing among agents. Specifically, the multi-agent system may consider the practical setting where each agent is myopic and treats other agents as part of the environment. The global information (e.g., latent state z(t) and latent intention w(t) from other agents) at time step t may be represented as Iₜ, which contains all the information in the system. During the interaction with the environment, agent i may choose an action a_{i,t}~πᵢ based on received information Tᵢ(Iₜ) and current state x_{i,t}. Then the goal of agent i is to find a policy (πᵢ(⋅|x_{i,t},Tᵢ(Iₜ)) that maximizes its value function vᵢ(x_{i,t}) Δ=Eₐ_{ᵢ}_{~π}_{ᵢ}[Q^{π}^{ᵢ}(x_{i,t},a_{i,t})], with Q-function Qᵢ^{π}(x_{i,t}, a_{i,t})=Eₐ_{ᵢ}_{~π}_{ᵢ}[Σₜγ^{t}r_{i,t}] being the expected return when the action a_{i,t} is chosen at state x_{i,t}.

The value function vᵢ(x_{i,t+1}) may represent the expected long-term reward an agent i can achieve from a given state x_{i,t+1} by following a specific policy πᵢ. The value function integrates insights from the dynamics predictor (or latent state z), reward predictor, and continue predictor, providing a comprehensive measure of the quality of a state or action. This helps the vehicle computing system 200 select actions that maximize the expected cumulative reward while accounting for future states and their potential outcomes.

Actions are determined by integrating predictions and evaluations from all components of the generalization module. At each time step k, the system evaluates the predicted future latent states \hat{z}ₜ₊ₖ, the corresponding rewards \hat{r}ₜ₊ₖ, and the likelihood of success ĉₜ₊ₖ. Using this information, the vehicle computes the value of potential actions âₜ₊ₖ by optimizing its policy πᵢ to maximize the value function vᵢ(x_{i,t+k}). Therefore, for time t+1, the action âₜ₊₁ can be predicted using the next latent states \hat{z}ₜ₊₁, the corresponding rewards \hat{r}ₜ₊₁, and the likelihood of success ĉₜ₊₁. For example, the system may select an action that ensures a smooth lane change, reduces collision risk, or optimizes traffic flow. By balancing immediate rewards with long-term goals, the system ensures that its decisions are both reactive to current conditions and proactive in navigating complex environments.

FIG. 3B illustrates a state diagram of an interplay between two agents (vehicles) employing a world model to come up with generalizations. The two agents may share latent state and latent intentions [zᵢ(t), wᵢ(t)] via lightweight communications. In some embodiments, the two agents may share latent state, hidden state, and latent intention [zᵢ(t), hᵢ(t), wᵢ(t)] via lightweight communications. A first agent 320A, based on the latent state and the latent intention of a second agent 320B and its own, may derive generalizations including a predicted latent state \hat{z}_{1,t+k} and a future action state a_{1,t+k}, where k represents different time intervals. The second agent 320B, based on the latent state and the latent intention of the first agent 320A, may derive generalization including a predicted latent state \hat{z}_{2,t+k} and a future action state a_{2,t+k}.

The first agent 320A may collect first sensory data, or first sensory input o_{1,t} using one or more sensors. The first agent 320A may then encode (e.g., using the encoding module 206A1 or the encoder model) the first sensory input o_{1,t} to determine a first latent state z_{1,t}. In some embodiments, the first agent 320A may encode the first hidden state data h_{1,t} or representation of information from past observations and actions maintained over time, along with the first sensory input to determine a first latent state data z_{1,t}. For example, the hidden state data may be recent positions and speeds of the vehicle. The first agent 320A may additionally encode the first waypoint data (e.g., derived using the software architecture of FIG. 2B) to determine a first latent intention w_{1,t}. The first agent 320A may then transmit the first latent state z_{1,t} and the first latent intention w_{1,t} to the second agent 320B. In some embodiments, The first agent 320A may then transmit the first latent state z_{1,t} and the first latent intention w_{1,t} to the second agent 320B based on the prediction-accuracy-driven information sharing mechanism.

The second agent 320B may collect second sensory data, or second sensory input o_{2,t} using one or more sensors. The second agent 320B may then encode the second sensory input o_{2,t} to determine a second latent state data z_{2,t}. In some embodiments, a second hidden state data h_{2,t}, or representation of information from past observations and actions maintained over time to provide context for decision-making, may be used along with the sensory input to determine a second latent state data z_{2,t}. The combination of the first hidden state data h_{1,t} and the first latent state z_{1,t} may be represented as a second state x_{1,t}. The second agent 320B may additionally encode second waypoint data to determine a second latent intention w_{2,t}. The second agent 320B may then transmit the second latent state z_{2,t} and the second latent intention w_{2,t} to the first agent 320A. In some embodiments, the second agent 320B may then transmit the second latent state z_{2,t} and the second latent intention w_{2,t} to the first agent 320A based on the prediction-accuracy-driven information sharing mechanism.

In some embodiments, the first agent 320A may decode the second latent state z_{2,t} and the second latent intention w_{2,t} into the second environment representation data and the second waypoint data. The first agent 320A may then combine the first sensory data and the second environment representation data to generate first fused sensory data. The first agent 320A may then encode the first fused sensory data, the first waypoint data, and the second waypoint data to obtain a first latent fused state, the first latent intention, and the second latent intention. The first latent fused state may then be utilized as the first latent state z_{1,t}, and the first latent intention and the second latent intention may be utilized as the first intention w₁.

In some embodiments, the second agent 320B may decode the first latent state z_{1,t} and the first latent intention w_{1,t} into the first environment representation data and the first waypoint data. The second agent 320B may then combine the first environment representation data and the second sensory data to determine a second fused sensory data. The second agent 320B may then encode the second fused sensory data, the first waypoint data, and the second waypoint data to obtain a second latent fused state, the first latent intention, and the second latent intention. The second latent fused state may then be utilized as the second latent state z_{2,t}, and the first latent intention and the second latent intention may be utilized as the first intention w₂.

The first agent 320A may then proceed to determine a first reward r_{1,t} by applying an augmented model p on the first latent state z_{1,t} and the first hidden state data h_{1,t}, and determine a first continuation by applying the augmented model p on the first latent state z_{1,t} and the first hidden state data h_{1,t}. The first agent 320A may then determine a first value v_{1,t} by applying a value function to the first latent state z_{1,t}, the first hidden state data h_{1,t}, and the first reward r_{1,t} to determine a first action a_{1,t}. The first agent 320A may then determine a next hidden state h_{1,t} by applying a sequence model f_{φ} to the first latent state z_{1,t}, the first hidden state data h_{1,t}, and the first action a_{1,t}. The first agent 320A may then determine a first dynamic predictor \hat{z}_{1,t+1} based on the next hidden state h_{1,t+1}. This process may continue iteratively for up to k time intervals (t+k), enabling the first agent 320A to predict future states, evaluate rewards, and refine actions over an extended horizon to ensure optimal decision-making and adaptability to dynamic environments.

The second agent 320B may then proceed to determine a first reward r_{1,t} by applying the augmented model p_{φ} on the second latent state z_{2,t} and the second hidden state data h_{2,t}, and determine a second continuation by applying the augmented model p_{φ} on the second latent state z_{2,t} and the second hidden state data h_{2,t}. The second agent 320B may then determine a second value v_{2,t} by applying a value function to the second latent state z_{2,t}, the second hidden state data h_{2,t}, and the second reward r_{2,t} to determine a second action a_{2,t}. The second agent 320B may then determine a subsequent hidden state h_{2,t+1} by applying the sequence model f_{φ} to the second latent state z_{2,t}, the second hidden state h_{2,t}, and the second action a_{2,t}. The second agent 320B may then determine a second dynamic predictor z_{2,t+1} based on the subsequent hidden state h_{2,t+1}. This process may continue iteratively for up to k time intervals (t+k), enabling the second agent 320B to predict future states, evaluate rewards, and refine actions over an extended horizon to ensure optimal decision-making and adaptability to dynamic environments.

In FIG. 3C, an algorithmic representation 330 for determining a dynamic predictor z_{i,t+k} and a hidden state h_{i,t+k} for up to k time intervals is shown. The algorithmic representation 330 may utilize the sequence model f_{φ}, the augmented model p_{φ}, the encoder and decoder, and other models to determine the dynamic predictor z_{i,t+k} and the hidden state h_{i,t+k}. Each agent i in FIG. 3B may also utilize the algorithm of FIG. 3C to determine the dynamic predictor and the hidden state iteratively for up to k time intervals.

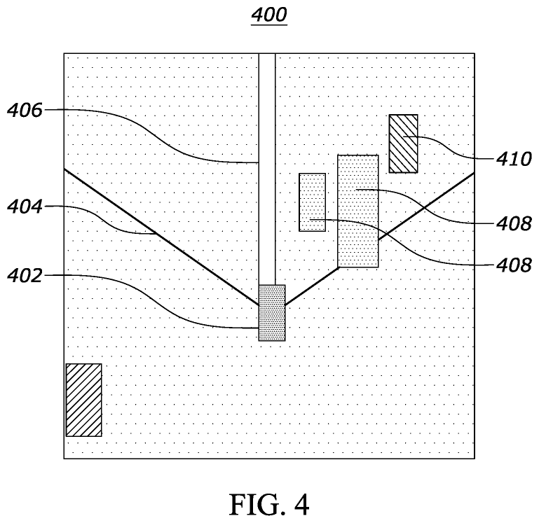

FIG. 4 presents a visual output (e.g., Bird's Eye View (BEV)) generated by the model. The visual output may comprise a vehicle 402, a line of sight 404, a predicted path 406, identified objects 408, and non-identified object 410. The identified objects 408 represent objects that were recognized based on the vehicle's own sensory data and processing. In contrast, the non-identified objects 410 represent objects that were detected or inferred with the assistance of latent state and latent intention data shared by other agents. It should be appreciated that when predicting the state a plurality of future points in time, the position of the tracked objects 408, 410 may shift based on the respectively predicted trajectories relative to the planned trajectory of the vehicle 402.

To adaptively determine when and what information to share, each agent may continuously monitors its prediction performance by evaluating prediction errors. For agent i at time t, this may involve comparing previously predicted latent states and intentions \hat{X}_{i,t}={\hat{z}_{i,t-k}, ŵ_{i,t-k}}ₖ₌₀^{K-1} against the actual observations X_{i,t}={z_{i,t-k}, w_{i,t-k}}ₖ₌₀^{K-1} from the last K time steps. The prediction error may be calculated as E_{i,t}=∥\hat{X}_{i,t}−X_{i,t}∥. If this error exceeds a predefined threshold c, the agent may increase its communication range and exchanges relevant latent information. To increase the communication range, the vehicle 402 may increase a transmit power of a transceiver used to broadcast a polling request for latent information, switch communication modes to a longer range communication protocol (e.g., switching from Wi-Fi to LoRaWan), query a wider range of vehicle associated with locations maintained in a vehicle database to identify additional vehicles from which to request latent information, etc. This adaptive process ensures that only necessary information is shared, significantly reducing communication overhead while maintaining prediction accuracy. As a result, reducing the prediction error may contribute to minimizing the sub-optimality gap in the value function, thereby improving the overall performance of the multi-agent system.

FIG. 5 displays a comprehensive flow diagram of a multi-agent sharing information to determine generalizations including path planning, decisions, and predictions. FIG. 5 includes three agents, an ego vehicle 502A, a first vehicle 502B, and a second vehicle 502C. The ego vehicle 502A may use information from the first vehicle 502B and the second vehicle 502C to determine generalization.

Each agent may have its own observation data (or sensory data) collected using one or more sensors. The ego vehicle 502A may use a RGB camera and a LIDAR 504A to collect ego observation data. The first vehicle 502B may use a RGB camera 504B to collect first observation data. The second vehicle 502C may use a RGB camera and a radar 504C to collect second observation data.

The ego vehicle 502A, upon collecting the ego observation data, may use the ego observation data to derive with ego waypoint data. The ego vehicle 502A may use the internal path-planning algorithms (e.g., software architecture of FIG. 2B) on the ego observation data to derive with sequence of target points that the vehicle plans on travelling. The ego vehicle 502A may then use a bird's eye view generator (e.g., BEV generator module 206D) on the ego observation data and the ego waypoint data to generate an ego local bird's eye view (BEV) 506A. Similarly, the first vehicle 502B may use the internal path-planning algorithms using the first observation data to determine first waypoint data, and use the bird's eye view generator on the first observation data and the first waypoint data to generate a first BEV 506B. The second vehicle 502C may use the internal path-planning algorithms using the second observation data to determine second waypoint data, and use the bird's eye view generator on the second observation data and the second waypoint data to generate a second BEV 506C.

The first vehicle 502B may then use a first encoder 508B (e.g., encoder module 206A1) to encode the first BEV 506B to determine a first latent state z_{1,t} and a first latent intention w₁. In some embodiments, the first vehicle 502B may encode the first observation data to determine the first latent state z_{1,t} and encode the first waypoint data to determine the first latent intention w₁. In some other embodiments, the first vehicle 502B may encode a first hidden state h_{1,t} and the first observation data to determine the first latent state z_{1,t}. The first hidden state h_{1,t} may indicate contextual information about past observations or actions of the first vehicle 502B. For example, the first hidden state h_{1,t} may comprise recent positions and speeds of nearby vehicles, a sequence of traffic light changes, or pedestrian movements observed over the last few seconds. The first vehicle 502B may then proceed to transmit the first latent state z_{1,t} and the first latent intention w₁ to the ego vehicle 502A.

The second vehicle 502C may then use a second encoder 508C to encode the second BEV 506C to determine a second latent state z_{2,t} and a second latent intention w₂. In some embodiments, the second vehicle 502C may encode the second observation data to determine the second latent state z_{2,t} and encode the second waypoint data to determine the second latent intention w₂. In some other embodiments, the second vehicle 502C may encode a second hidden state h_{2,t} and the second observation data to determine the second latent state z_{2,t}. The second hidden state h_{2,t} may indicate contextual information about past observations or actions of the second vehicle 502C. The second vehicle 502C may then proceed to transmit the second latent state z_{2,t} and the second latent intention w₂ to the ego vehicle 502A.

The ego vehicle 502A, upon receiving the first latent state z_{1,t} and the first latent intention w₁, may use a decoder 512 to decode the first latent state z_{1,t} into the first environment representation data and the first latent intention w₁ into the first waypoint data. The ego vehicle 502A may then use the bird's eye view generator to reconstruct the first BEV 506B view using the first environment representation data and the first waypoint data. The ego vehicle 502A, upon receiving the second latent state z_{2,t} and the second latent intention w₂, may decode the second latent state z_{2,t} into the second environment representation data, and the second latent intention w₂ into the second waypoint data. The ego vehicle 502A may then use the bird's eye view generator to reconstruct the second BEV 506C using the second environment representation data and the second waypoint data.

The ego vehicle 502A may combine the ego BEV 506A, the first BEV 506B, and the second BEV 506C to determine a fused BEV 514. In some embodiments, the ego vehicle 502A, instead of generating the first BEV and the second BEV, may generate the fused BEV based on the ego observation data, the first observation data, the second observation data, the ego waypoint data, the first waypoint data, and the second waypoint data. For example, the ego vehicle 502A may generate fused observation data (e.g., fused state data), and use the fused observation data along with the ego waypoint data, the first waypoint data, and the second waypoint data to generate the fused BEV. The fused BEV 514 may provide a more comprehensive view of the environment than any component BEV that has been fused into the fused BEV 514. The fused BEV 514 may map the ego waypoint data, first waypoint data, and the second waypoint data indicating predicted path of the ego vehicle 502A, the first vehicle 502B, and the second vehicle 502C to the fused BEV 514. This combined perspective may allow the ego vehicle 502A to understand the relative positions, trajectories, and intentions of nearby agents, as well as to identify potential obstacles and hazards in a broader spatial context.

During this information sharing process, the ego vehicle 502A may evaluate its prediction errors by comparing the previously predicted latent states against actual observations. If the prediction error exceeds a threshold, the ego vehicle may adjust its communication strategy, potentially increasing its communication range to acquire more information from additional agents. This prediction-accuracy-driven approach may ensure that information sharing occurs only when necessary to maintain accurate predictions, thereby reducing overall communication overhead while preserving prediction performance. This adaptive mechanism may enhance both partial observability (by obtaining only necessary information from other agents) and non-stationarity (by continuously updating and enhancing predictions based on the latest shared information).

The ego vehicle 502A, upon determining the fused BEV 514, may encode the fused BEV 514 using an encoder 518 to determine a latent fused state, latent intentions (including an ego latent intention, the first latent intention, and the second latent intention). Based on the latent fused state and the latent intentions, the ego vehicle 502A may derive generalizations, predicting latent states 520 of the ego vehicle 502A and actions 524 at different time intervals K. The ego vehicle 502A may determine the actions 524 by applying a memory augmented neural network 522 to the latent fused state and latent fused waypoint. Details relating to deriving generalizations can be found in FIG. 3B.

In some embodiments, the ego vehicle 502A, upon receiving the first latent state, the first latent intention, the second latent state, and the second latent intention, may fuse the ego observation data, the first latent state, and the second latent state to determine a latent fused state. The ego vehicle 502A may then proceed to convert the latent fused state into a fused BEV 514.

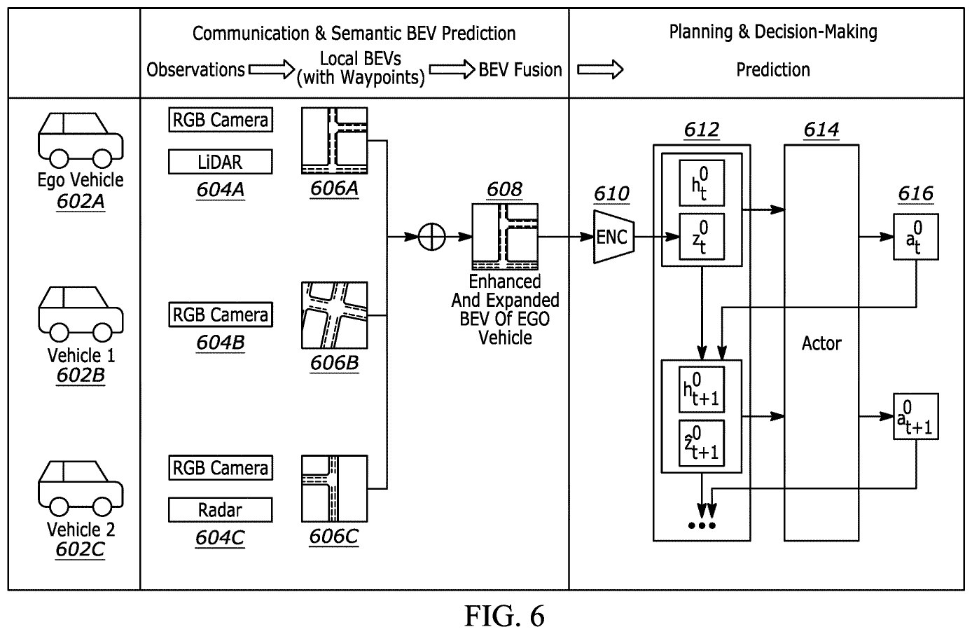

FIG. 6 illustrates a multi-agent system for determining generalizations, where each agent has a different encoding model. Because each agent has a different encoding model, the other vehicles (e.g., a first vehicle 602B and a second vehicle 602C) are unable to share latent states and latent intentions to an ego vehicle 602A as illustrated in FIG. 5. Said another way, the ego vehicle 602A would not be able to decode the latent states and latent intentions of the other vehicles to obtain the observation data and waypoint data due to the differences in encoding. Therefore, the multi-agent system in FIG. 6 may not enjoy the benefit of low communication load when communicating with each other. However, the multi-agent system may still utilize the world model to derive quick generalizations. The multi-agent system may comprise the ego vehicle 602A, the first vehicle 602B, and the second vehicle 602C. The ego vehicle 602A may receive information from the first vehicle 602B and the second vehicle 602C.

Each agent may have its own observation data collected using one or more sensors. The ego vehicle 602A may use a RGB camera and a LIDAR 604A to collect ego observation data. The first vehicle 602B may use a RGB camera 604B to collect first observation data. The second vehicle 602C may use a RGB camera and a radar 604C to collect second observation data.

The ego vehicle 602A, upon collecting the ego observation data, may use the ego observation data to derive with ego waypoint data. The ego vehicle 602A may use the internal path-planning algorithms (FIG. 2B) using the ego observation data to derive a sequence of target points that the vehicle plans on travelling. The ego vehicle 602A may then use a bird's eye view generator on the ego observation data and the ego waypoint data to generate an ego local bird's eye view (BEV) 606A. Similarly, the first vehicle 602B may use the internal path-planning algorithms using the first observation data to determine first waypoint data, and use the bird's eye view generator on the first observation data and the first waypoint data to generate a first BEV 606B. The second vehicle 602C may use the internal path-planning algorithms using the second observation data to determine second waypoint data, and use the bird's eye view generator on the second observation data and the second waypoint data to generate a second BEV 606C.

The first vehicle 602B may then proceed to transmit the first BEV 606B to the ego vehicle 602A. In some embodiments, the first vehicle 602B may transmit the first observation data and the first waypoint data to the ego vehicle 602A, and the ego vehicle 602A may proceed to determine the first BEV 606B using the BEV generator. The second vehicle 602C may proceed to transmit the second BEV 606C to the ego vehicle 602A. In some embodiments, the second vehicle 602C may transmit the second observation data and the second waypoint data to the ego vehicle 602A, and the ego vehicle 602A may proceed to determining the second BEV 606C using the BEV generator.

The ego vehicle 602A may combine the ego BEV 606A, the first BEV 606B, and the second BEV 606C to determine a fused BEV 608. In some embodiments, the ego vehicle 602A may generate the fused BEV 608 using the ego observation data, the first observation data, the second observation data, the ego waypoint data, the first waypoint data, and the second waypoint data. For example, the ego vehicle 502A may determine a fused observation data (e.g., fused state data), and use the fused observation data along with the ego waypoint data, the first waypoint data, and the second waypoint data to determine the fused BEV. The fused BEV 608 may provide a comprehensive view of the environment. This combined perspective may allow the ego vehicle 602A to understand the relative positions, trajectories, and intentions of nearby agents, as well as to identify potential obstacles and hazards in a broader spatial context.

The ego vehicle 602A, upon determining the fused BEV 608, may encode the fused BEV 608 using an encoder 610 to determine a latent fused state and latent intentions (including an ego latent intention, a first latent intention, and a second latent intention). Based on the latent fused state and the latent intentions, the ego vehicle 602A may derive generalizations, predicting latent states 612 of the ego vehicle 602A and actions 616 at different time intervals K. The ego vehicle 602A may determine the actions 616 by applying a memory augmented neural network 614 to the latent fused state and latent fused waypoint. Details to deriving generalizations can be found in FIG. 3B.

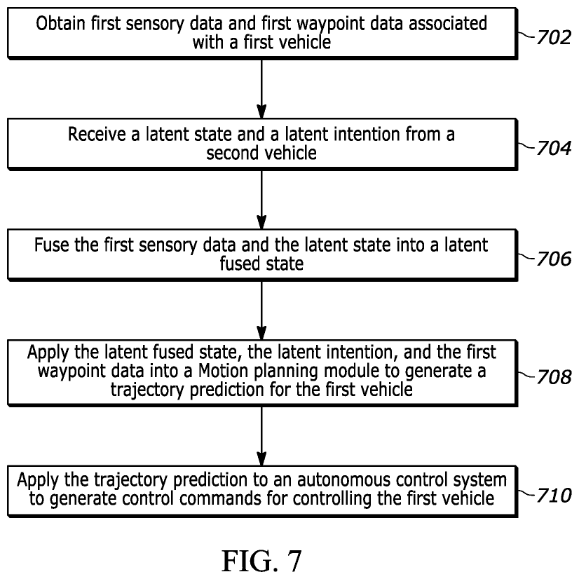

FIG. 7 depicts a computer-implemented method generating a trajectory prediction for a vehicle. Although the method 700 is described below with regard to a vehicle computing system 200 and components thereof as illustrated in FIG. 2, it will be understood that other similarly suitable devices and/or components may be used instead and that hardware systems, components, or infrastructure may be implemented.

At block 702, the vehicle computing system 200 may obtain first sensory data and first waypoint data associated with a first vehicle. The first sensory data may be data collected from one or more sensors, such as camera images, LiDAR scans, radar data, or GPS information, describing the first vehicle's environment and surroundings. The first waypoint data may be a sequence of planned target points or coordinates that represent the intended path or trajectory of the first vehicle, including planned movements such as lane changes, speed adjustments, or stops over a given time horizon. In some embodiments, the first sensory data may represent a bird's-eye-view of an environment proximate to the first vehicle.

At block 704, the vehicle computing system 200 may receive a latent state and a latent intention from a second vehicle. The latent state may represent encoded second sensory data associated with the second vehicle. The latent intention may represent encoded second waypoint data associated with the second vehicle. In some embodiments, the second vehicle may be located within a predefined distance threshold from the first vehicle. The predefined distance threshold may be based on a broadcasting signal range of the first vehicle, or a global positioning system (GPS) distance with respect to the first vehicle. In some embodiments, the latent state may include third sensory data associated with a third vehicle and the latent intention may include third waypoint data associated with the third vehicle. In some other embodiments, the latent state may have a smaller feature space than a second sensory data, and the latent intention may have a smaller feature space than a second waypoint data.

At block 706, the vehicle computing system may fuse the first sensory data and the latent state into a latent fused state. The latent fused state may represent a more comprehensive and accurate representation of the vehicle's environment. In some embodiments, the vehicle computing system may decode the latent state into environment representation data, and the latent intention into a second waypoint data. The vehicle computing system may then fuse the first sensory data and the environment representation data into a fused environment representation. The vehicle computing system may encode the fused environment representation into the latent fused state. In some other embodiments, the vehicle computing system may obtain first hidden state data associated with the first vehicle. The vehicle computing system may then fuse the first sensory data, the latent state, and the first hidden state into the latent fused state.

At block 708, the vehicle computing system may apply the latent fused state, the latent intention, and the first waypoint data into a route planning module to generate a trajectory prediction for the first vehicle. In some embodiments, the vehicle computing system may encode the first waypoint data. The vehicle computing system may then apply the latent fused state, the latent intention, and the encoded first waypoint data into the motion planning module to generate the trajectory prediction. In some other embodiments, the vehicle computing system may generate the trajectory prediction for a plurality of future time intervals. At block 710, the vehicle computing system may control the first vehicle based on the trajectory prediction.

In some embodiments, the vehicle computing system may execute the motion planning module on historical waypoint data and historical sensory data to generate the first waypoint data. By leveraging historical data, the motion planning module may generate a sequence of targe points that account for recuring obstacles, patterns, and behaviors. By leveraging historical waypoint data, the motion planning module may help with anticipating different scenarios and situations.

In some embodiments, the vehicle computing system may encode the first sensory data and the first waypoint data. The vehicle computing system may then transmit the encoded first sensory data and the encoded first waypoint data to the second vehicle. The motion planning module of the second vehicle may be configured to analyze the encoded first sensory data and the encoded first waypoint data to generate a trajectory prediction for the second vehicle. In further embodiments, the vehicle computing system may encode the first sensory data by defining a subset of the first sensory data based on an absolute position of the first vehicle to the second vehicle. The vehicle computing system may then encode the subset of the first sensory data without encoding other portions of the first sensor data.

In some embodiments, the vehicle computing system may determine that a prediction error for a past trajectory prediction is above a predefined threshold. The vehicle computing system may then expand a communication range of the one or more transceivers of the first vehicle. The vehicle computing system may then receive one or more latent states and latent intentions from one or more vehicles in the communication range.

### EXAMPLES

Aspect 1. A method for generating a trajectory prediction for a vehicle, the method comprising: obtaining, by one or more processors, first sensory data and first waypoint data associated with a first vehicle; receiving, by the one or more processors, a latent state and a latent intention from a second vehicle, wherein the latent state represents encoded second sensory data associated with the second vehicle, wherein the latent intention represents encoded second waypoint data associated with the second vehicle; fusing, by the one or more processors, the first sensory data and the latent state into a latent fused state; applying, by the one or more processors, the latent fused state, the latent intention, and the first waypoint data into a motion planning module to generate a trajectory prediction for the first vehicle; and applying, by the one or more processors, the trajectory prediction to an autonomous control system to generate control commands for controlling the first vehicle.

Aspect 2. The method of aspect 1, wherein fusing the first sensory data and the latent state into the latent fused state further comprises: decoding, by the one or more processors, the latent state into environment representation data, and the latent intention into a second waypoint data; fusing, by the one or more processors, the first sensory data and the environment representation data into a fused environment representation; and encoding, by the one or more processors, the fused environment representation into the latent fused state.

Aspect 3. The method of aspect 2, wherein applying the latent fused state, the latent intention, and the first waypoint data into the motion planning module to generate the trajectory prediction for the first vehicle further comprises: encoding, by the one or more processors, the first waypoint data; and applying, by the one or more processors, the latent fused state, the latent intention, and the encoded first waypoint data into the motion planning module to generate the trajectory prediction

Aspect 4. The method of any one of aspects 1 to 3, wherein the latent state has a smaller feature space than a second sensory data.

Aspect 5. The method of either one of aspects 1 to 4, wherein the latent intention has a smaller feature space than a second waypoint data.

Aspect 6. The method of any one of aspects 1 to 5, wherein the second vehicle is located within a predefined distance threshold from the first vehicle.

Aspect 7. The method of aspect 6, wherein the predefined distance threshold is based on a broadcasting signal range of the first vehicle.

Aspect 8. The method of either one of aspects 6 or 7, wherein the predefined distance threshold is based on a global positioning system (GPS) distance with respect to the first vehicle.

Aspect 9. The method of any one of aspects 1 to 8, wherein generating the trajectory prediction comprises: generating, by the one or more processors, the trajectory prediction for a plurality of future time intervals.

Aspect 10. The method of any one of aspects 1 to 9, further comprising: executing, by the one or more processors, the motion planning module on historical waypoint data and historical sensory data to generate the first waypoint data.

Aspect 11. The method of any one of aspects 1 to 10, further comprising: encoding, by the one or more processors, the first sensory data and the first waypoint data; and transmitting, by the one or more processors, the encoded first sensory data and the encoded first waypoint data to the second vehicle, wherein a motion planning module of the second vehicle is configured to analyze the encoded first sensory data and the encoded first waypoint data to generate a trajectory prediction for the second vehicle.

Aspect 12. The method of aspect 11, wherein encoding the first sensory data comprises: defining, by the one or more processors, a subset of the first sensory data based on an absolute position of the first vehicle to the second vehicle; and encoding, by the one or more processors, the subset of the first sensory data without encoding other portions of the first sensory data.

Aspect 13. The method of any one of aspect 11 or 12, wherein the first vehicle comprises one or more transceivers, further comprising: determining, by the one or more processors, that a prediction error for a past trajectory prediction is above a predefined threshold; expanding, by the one or more processors, a communication range of the one or more transceivers of the first vehicle; and receiving, by the one or more processors, one or more latent states and latent intentions from one or more vehicles in the expanded communication range.

Aspect 14. The method of any one of aspects 1 to 13, wherein the latent state includes third sensory data associated with a third vehicle and the latent intention includes third waypoint data associated with the third vehicle.

Aspect 15. The method of any one of aspects 1 to 14, wherein the first sensory data represents a bird's-eye-view of an environment proximate to the first vehicle.

Aspect 16. The method of any one of aspects 1 to 15, wherein fusing the first sensory data and the latent state into the latent fused state further comprises: obtaining, by the one or more processors, first hidden state data associated with the first vehicle; and fusing, by the one or more processors, the first sensory data, the latent state, and the first hidden state into the latent fused state.

Aspect 17. A computer system for generating a trajectory prediction for a vehicle, comprising: one or more processors, and a tangible, non-transitory memory coupled to the one or more processors and storing executable instructions that, when executed by the one or more processors, cause the computer system to: obtain first sensory data and first waypoint data associated with a first vehicle; receive a latent state and a latent intention from a second vehicle, wherein the latent state represents encoded second sensory data associated with the second vehicle, wherein the latent intention represents encoded second waypoint data associated with the second vehicle; fuse the first sensory data and the latent state into a latent fused state; apply the latent fused state, the latent intention, and the first waypoint data into a motion planning module to generate a trajectory prediction for the first vehicle; and apply the trajectory prediction to an autonomous control system to generate control commands for controlling the first vehicle.

Aspect 18. The computer system of aspect 17, wherein instructions that, when executed by the one or more processors, cause the computer system to perform the method of any one of claims 2 to 16.

Aspect 19. A non-transitory computer-readable medium storing executable instructions for generating a trajectory prediction for a vehicle that, when executed by one or more processors, causes the one or more processors to: obtain first sensory data and first waypoint data associated with a first vehicle; receive second sensory data and second waypoint data from a second vehicle; fuse the first sensory data and the second sensory data into a fused sensory data; encode the fused sensory data into a latent fused state, the first waypoint data, and the second waypoint data; apply the latent fused state, the encoded first waypoint data, and the encoded second waypoint data into a motion planning module to generate a trajectory prediction for the first vehicle; and apply the trajectory prediction to an autonomous control system to generate control commands for controlling the first vehicle.

Aspect 20. The non-transitory computer-readable medium of aspect 19, wherein the instructions further cause the one or more processors to perform the method of any one of claims 2 to 16.

### Exemplary Extended Reality Environment within an Autonomous Vehicle

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Moreover, the systems and methods described herein are directed to an improvement to computer functionality and improve the functioning of conventional computers.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for systems and methods for autonomous vehicle services and operations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

What is claimed is:

1. A method for generating a trajectory prediction for a vehicle, the method comprising:
obtaining, by one or more processors, first sensory data and first waypoint data associated with a first vehicle;
receiving, by the one or more processors, a latent state and a latent intention from a second vehicle, wherein the latent state represents encoded second sensory data associated with the second vehicle, wherein the latent intention represents encoded second waypoint data associated with the second vehicle;
fusing, by the one or more processors, the first sensory data and the latent state into a latent fused state;
applying, by the one or more processors, the latent fused state, the latent intention, and the first waypoint data into a motion planning module to generate a trajectory prediction for the first vehicle; and
applying, by the one or more processors, the trajectory prediction to an autonomous control system to generate control commands for controlling the first vehicle.

2. The method of claim 1, wherein fusing the first sensory data and the latent state into the latent fused state further comprises:
decoding, by the one or more processors, the latent state into environment representation data, and the latent intention into a second waypoint data;
fusing, by the one or more processors, the first sensory data and the environment representation data into a fused environment representation; and
encoding, by the one or more processors, the fused environment representation into the latent fused state.

3. The method of claim 2, wherein applying the latent fused state, the latent intention, and the first waypoint data into the motion planning module to generate the trajectory prediction for the first vehicle further comprises:
encoding, by the one or more processors, the first waypoint data; and
applying, by the one or more processors, the latent fused state, the latent intention, and the encoded first waypoint data into the motion planning module to generate the trajectory prediction.

4. The method of claim 1, wherein the latent state has a smaller feature space than a second sensory data.

5. The method of claim 1, wherein the latent intention has a smaller feature space than a second waypoint data.

6. The method of claim 1, wherein the second vehicle is located within a predefined distance threshold from the first vehicle.

7. The method of claim 6, wherein the predefined distance threshold is based on a broadcasting signal range of the first vehicle.

8. The method of claim 6, wherein the predefined distance threshold is based on a global positioning system (GPS) distance with respect to the first vehicle.

9. The method of claim 1, wherein generating the trajectory prediction comprises:
generating, by the one or more processors, the trajectory prediction for a plurality of future time intervals.

10. The method of claim 1, further comprising:
executing, by the one or more processors, the motion planning module on historical waypoint data and historical sensory data to generate the first waypoint data.

11. The method of claim 1, further comprising:
encoding, by the one or more processors, the first sensory data and the first waypoint data; and
transmitting, by the one or more processors, the encoded first sensory data and the encoded first waypoint data to the second vehicle, wherein a motion planning module of the second vehicle is configured to analyze the encoded first sensory data and the encoded first waypoint data to generate a trajectory prediction for the second vehicle.

12. The method of claim 11, wherein encoding the first sensory data comprises:
defining, by the one or more processors, a subset of the first sensory data based on an absolute position of the first vehicle to the second vehicle; and
encoding, by the one or more processors, the subset of the first sensory data without encoding other portions of the first sensory data.

13. The method of claim 11, wherein the first vehicle comprises one or more transceivers, further comprising:
determining, by the one or more processors, that a prediction error for a past trajectory prediction is above a predefined threshold;
expanding, by the one or more processors, a communication range of the one or more transceivers of the first vehicle; and
receiving, by the one or more processors, one or more latent states and latent intentions from one or more vehicles in the expanded communication range.

14. The method of claim 1, wherein the latent state includes third sensory data associated with a third vehicle and the latent intention includes third waypoint data associated with the third vehicle.

15. The method of claim 1, wherein the first sensory data represents a bird's-eye-view of an environment proximate to the first vehicle.

16. The method of claim 1, wherein fusing the first sensory data and the latent state into the latent fused state further comprises:
obtaining, by the one or more processors, first hidden state data associated with the first vehicle; and
fusing, by the one or more processors, the first sensory data, the latent state, and the first hidden state into the latent fused state.

17. A computer system for generating a trajectory prediction for a vehicle, comprising:
one or more processors, and
a tangible, non-transitory memory coupled to the one or more processors and storing executable instructions that, when executed by the one or more processors, cause the computer system to:
obtain first sensory data and first waypoint data associated with a first vehicle;
receive a latent state and a latent intention from a second vehicle, wherein the latent state represents encoded second sensory data associated with the second vehicle, wherein the latent intention represents encoded second waypoint data associated with the second vehicle;
fuse the first sensory data and the latent state into a latent fused state;
apply the latent fused state, the latent intention, and the first waypoint data into a motion planning module to generate a trajectory prediction for the first vehicle; and
apply the trajectory prediction to an autonomous control system to generate control commands for controlling the first vehicle.

18. The computer system of claim 17, wherein the instructions, when executed by the one or more processors, cause the computer system to:
decode the latent state into environment representation data, and the latent intention into a second waypoint data;
fuse the first sensory data and the environment representation data into a fused environment representation; and
encode the fused environment representation into the latent fused state.

19. A non-transitory computer-readable medium storing executable instructions for generating a trajectory prediction for a vehicle that, when executed by one or more processors, causes the one or more processors to:
obtain first sensory data and first waypoint data associated with a first vehicle;
receive second sensory data and second waypoint data from a second vehicle;
fuse the first sensory data and the second sensory data into a fused sensory data;
encode the fused sensory data into a latent fused state, the first waypoint data, and the second waypoint data;
apply the latent fused state, the encoded first waypoint data, and the encoded second waypoint data into a motion planning module to generate a trajectory prediction for the first vehicle; and
apply the trajectory prediction to an autonomous control system to generate control commands for controlling the first vehicle.

20. The non-transitory computer-readable medium of claim 19, wherein the instructions, when executed, further cause the one or more processors to:
decode the latent state into environment representation data, and a latent intention into a second waypoint data;
fuse the first sensory data and the environment representation data into a fused environment representation; and
encode the fused environment representation into the latent fused state.
